(19) United States
(12) Patent Application Publication
(10) Pub. No.: US 2016/0026032 A1
(43) Pub. Date: Jan. 28, 2016

(54) ELECTRONIC SHELF (eShelf)

(71) Applicant: Chad B. Moore, Corning, NY (US)

(72) Inventor: Chad B. Moore, Corning, NY (US)

(21) Appl. No.: 14/805,590

(22) Filed: Jul. 22, 2015

Related U.S. Application Data
(60) Provisional application No. 62/027,938, filed on Jul. 23, 2014.
(60) Provisional application No. 62/169,207, filed on Jun. 1, 2015.

(51) Int. Cl. G02F 1/1333; H01Q 1/22; G02F 1/1343; G06Q 10/08; G09G 3/36; G06T 7/00; G06K 9/62; G06K 9/00; G06K 7/10; G02F 1/1339

(52) U.S. Cl. CPC G02F 1/133377; G06K 7/10316; H01Q 1/2216; G02F 1/134336; G02F 1/13394; G09G 3/36; G06T 7/0042; G06K 9/6201; G06K 9/00624; G02F 1/13439; G06Q 10/087; G09G 2380/04

(57) ABSTRACT

The invention is an electronic shelf (eShelf). The eShelf uses highly conductive electrodes to solve the long-line addressing problems using very-simple, low-cost manufacturing processes to build very-long, reflective, “no-power”, full-color, liquid crystal displays (LCDs) with perfect image retention. The electronic shelf is composed of an eSheet cholesteric LCD attached to a shelf product sensor pad that can turn a normal store aisle into an interactive, full-color, fun and informative shopping experience. The eShelf is the next generation of in-store smart technology combining product management with customer interaction and advertising. The true success of the eShelf will depend on the countless apps that will run on or interact with the eShelf to help customers make their purchasing decisions. These software applications will allow the eShelf to interact with the customers smart mobile device, such as, a tablet, smartphone, smartwatch, or Google Glass.

### REFERENCE TO RELATED APPLICATIONS

This application claims an invention that was disclosed in one or more of the following provisional applications:
1) Provisional Application No. 62/027,938, filed Jul. 23, 2014, entitled “ELECTRONIC SHELF (eShelf)”;
2) Provisional Application No. 62/169,207, filed Jun. 1, 2015, entitled “ELECTRONIC SHELF (eShelf)”;

The benefit under 35 USC §119(e) of the United States provisional applications is hereby claimed, and the aforementioned applications are hereby incorporated herein by reference.

### FIELD OF THE INVENTION

The invention pertains to the field of an electronic display at the shelf rail pricing location. The invention covers many aspects of the long, full-color, reflective, bistable Liquid Crystal Displays (LCDs) and different sensors attached to the displays, as well as, how shoppers and store clerks interact with the electronic shelf (eShelf).

### BACKGROUND OF THE INVENTION

The number one market share for pricing labels on a shelf edge is printed paper labels. The printed label is usually printed on a piece of paper then slid behind a clear plastic cover, like in FIG. 1, or is printed on a label with an adhesive back and stuck directly to the shelf edge, like in FIG. 2. The purpose of these labels are to provide pricing and other information about the product that resides on the shelf. In some parts of the world the pricing label is being converted to reflective electronic displays, like in FIG. 3. However, in the USA the customer has been shopping with the help of color labeling at the shelf edge, as seen in FIG. 4, and believes that all visual display interactions need to be in color. Color adds many different dimensions to the shopper's experience. Therefore, any technology that is going to supplant the printed label must be a full-color, matrix-addressable, display that requires zero energy to continuously display its image. The future electronic display must reflect color across the entire visible spectrum and its image must be capable of being latched in this reflective colored state.

In order to meet the low-cost requirements of an electronic pricing label, monochrome, segment-addressed, liquid crystal displays (LCDs) were introduced. These Electronic Shelf Labels (ESLs) can meet the low-cost (˜$5 per unit) requirements for electronic display pricing replacement of the printed label, however they are limited to changing the price of the product or turning a word, such as, “unit” ON and OFF, as seen in FIG. 5. In the late 1990s a professor from MIT, Joseph Jacobson, discovered how to microencapsulate a solution of black-and-white pigment to stop pigment agglomeration in the panel and E Ink Corporation was born. Through 2000 the monochrome segmented LCD panels have been losing out to black and white, electrophoretic, matrix-addressable, E Ink displays. Black and white displays cannot differentiate products or their attributes. E Ink displays images on their panels by selectively swapping oppositely charged black and white pigment particles from one side of the microcapsule to the other side of the microcapsule (i.e. toward the viewer or why towards the back of the display). In 2015, E Ink added a third, differently charged, RED particle to the black and white pigment mixture to create a red-black-and-white display, as shown in FIG. 6. Red will help draw some attention to the Electronic Shelf Label (ESL), however full-color is necessary for advertising at price rail. Advertising at point of purchase decision {price rail} is the most effective method of influencing the customer's purchasing decision.

A supermarket may have 100,000 products distributed on their shelves throughout the store. Each one of these products has to have pricing and product information. To date, the electronic shelf label has been a one-to-one replacement for the paper pricing label. Therefore, to replace all the paper labels in a supermarket 100,000 electronic pricing labels will be required. Since each electronic pricing label has a display, electronics, battery, wireless communication link, and housing, replacing the paper labels has not been an economical solution. In order to make the electronic shelf label an economic solution, the electronic shelf label will have to display the pricing information of many products on a single display. However, to display the pricing information of many products the electronic shelf label will have to be expanded from its traditional 2″ by 4″ form factor to 2″ by several feet. These very-long eShelf displays will require the pixels in the panel to be addressed over very long distances. This long-line addressing is very difficult to achieve, technically and economically. The electroded sheet, ‘eSheet’ technology, covered in U.S. Pat. Nos. 8,089,434, 8,106,853, and 8,166,649, included herein by reference, solves the long-line addressing problems and creates a low-cost, high-resolution, no-power, reflective, full-color LCD.

Year after year the LCD technology keeps expanding its empire and expanding into new markets. One of the last untapped markets for the dominant LCD technology is to expand into large-format reflective displays that require NO power to display full-color, high-resolution images. One of the problems with the present LCD technology is that it is used as a gate to let light through the pixel or block the light out. If this twisted nematic liquid crystal was used to form a reflective color display then 3 colored (red, green, and blue) subpixels will be required form the full-color image. Since the red subpixel only allows red light transmitted through and absorbs the other ⅔ of the light (green and blue) then the maximum reflectivity from that area is only 33%. Subtract from that 33% an additional 50% for the polarizer and the theoretical maximum reflectivity of a specific color from the pixel is a little over 16%. These displays are so dim that without power from the backlight they are hard to read and don't pop. They also need constant addressing of the liquid crystal to hold the pixels' colors, which requires energy. Few twisted nematic liquid crystals are bistable or even multistable. There is a liquid crystal that uses the nematic liquid crystal paddles and connects them to a chiral molecular core. The pitch of the ‘cork screwing’ molecular core determines the wavelength of circularly polarized light that is Bragg reflected from the twisting cholesteric liquid crystal. All other colors pass straight through the cholesteric liquid crystal. Therefore, to create a full-color display panel at least three primary liquid crystal panels will need to be stacked one on top of the next. This effectively triples the panel costs. The reflective cholesteric liquid crystal molecule has a bistable reflective voltage addressing threshold, therefore it can be addressed by simply sandwiching it between orthogonal conductive electrodes. The cholesteric liquid crystal panel does not require an expensive thin-film transistor (TFT) or active-matrix liquid crystal (AMLCD) addressing plane. The cholesteric liquid crystal display (Ch. LCD) technology is very sensitive to time at voltage during addressing to control both the addressability of the panel and to control the grayscale color. To overcome the cholesteric liquid crystal display addressing issues, the addressing distance must be very short (i.e. small displays) or the transparent conductive electrodes must be very conductive (much more than their theoretical limit) to be able to charge the high liquid crystal capacitance of the pixels along the addressing line quickly and accurately. The electroded sheet, ‘eSheet’ technology, covered in U.S. Pat. Nos. 8,089,434, 8,106,853, and 8,166,649, included herein by reference, solves the long-line addressing problems by using conductive wire electrodes to carry the current along the display lines while connecting the wires to transparent conductive electrode stripes to spread the voltage across the pixel width.

Placing an interactive electronic display on the price rail will more accurately keep the same price between the cash register and the shelf. Electronic shelf labels (ESLs) can help stores sell their products in many different new ways, such as, lowering the price of discontinued items or products reaching their expiration date to reduce inventory. However, these added benefits are passive. Replacing the paper labels with electronic shelf labels does nothing to engage the customer. The new full-color electronic shelf displays will have to interact with the customer and assist them in making their purchasing decisions. The electronic shelf edge displays will also have to interact with the store employees to assist them in stocking the shelves and aligning the pricing information and advertising to the products on the shelf. These long, full-color, LCD electronic shelves will require sensors at the shelf in order to interact with the customers. The sensors will have to sense the location of the products on the shelf to be able to align the electronic data with the products on the shelf. The eShelf will also have to be capable of tracking products being placed on or removed from the shelf, as well as, being able to communicate to the customer's wireless mobile device in order to interface with the customer.

In order to convert the shelf's price rail edge from paper over to an electronic display, the new technology must be capable of producing very long, matrix-addressable, full-color images that stay without any power. In order to thrive, get something done, and make it fun the new eShelf must be fully interactive.

It is the attempt of this patent to explain a technology that can be used to build long, full-color, interactive shelf rail display systems to display product information, as well as, help interact, manage and sell products.

### SUMMARY OF THE INVENTION

The invention is an electronic shelf (eShelf). The eShelf uses wire-based displays to solve the long-line cholesteric LCD addressing problems. The invention discloses a very-simple, low-cost manufacturing process to build long, reflective, “no power”, full-color, liquid crystal displays (LCDs) with perfect image retention for eShelves. The electronic shelf is composed of an eSheet cholesteric LCD attached to a shelf product sensor pad that can turn a normal store aisle into an interactive, full-color, fun and informative shopping experience. The true success of the eShelf will depend on the countless apps that will run on or interact with the customer's mobile device to help them make their purchasing decisions. These software applications will allow the eShelf to interact with the customer's smart mobile device such as a tablet, smartphone, smartwatch, or Google Glass. Interacting with the eShelf using a smart mobile headset, like Google Glass, provides a hands-free and heads-up interactive shopping and managing experience.

The revolutionary eSheet technology can produce eShelves that stretch the entire length of an aisle. Solving the long-line addressing allows for hundreds of products to be displayed on a single eShelf, making the “electronic price rail” an economical solution. The patented technology provides a simple low-cost method of manufacturing the eShelf's vibrant color LCDs. The displays can be extremely energy-efficient requiring NO power to reflect over 70% of the incident light across the entire color spectrum. EShelf product sensor pads can be made to detect many product attributes such as sizes, shapes, locations, weight, temperature, and even talk to any RFID tags. This information is not only shared with the attached LCD, which forms the basis of the eShelf, but it can also be wirelessly transferred to the store's database to manage the eShelf or to a smartphone, tablet, smartwatch, or Google Glass, to interact with a customer or staff. Antennas to wirelessly interact (Wi-Fi, NFC, Bluetooth, ZigBee, etc.) with customers, employees, the store, other eShelves or the internet can be incorporated into the eShelf. Solar cells, as well as, batteries can be integrated into the eShelf to power the electronics, radio and sensors. Installing the autonomous eShelves will be a breeze. Just clean off the shelf, slide the eShelf onto the retail shelf, place it into interactive mode, stock it with merchandise, and then let it interact with the customers.

The eSheet is the key invention that will enable long, energy-efficient, full-color LCDs allowing the LCD technology to expand its dominance to reflective displays. The eShelf is a one-dimensional solution for the eSheet technology, meaning that eSheet wire electrodes are only required for one direction. The eShelf is the perfect match for the eSheet LCD technology because all of the technical issues can be worked out in one direction before the displays are expanded into a large second direction for markets like Billboards and School Blackboards. The eSheet LCD technology solves the main Electronic Shelf Label market demand in the USA-color. Lenses can be added to the eSheet to make the images pop out of the display creating a three-dimensional effect. Lenses on the eSheet surface can also generate multi-view displays.

The eSheet technology is the enabling technology that will make the eShelf a reality. Although the eSheets are necessary to make large color displays, the true success of the eShelf market will depend on being able to engage the customer and get them to interact with the eShelf. The large color displays will open up advertising at price rail. A very effective method of engaging the customer is getting connected to the customer's second brain, their smartphone, tablet, Google Glass or Apple Watch. Since the eShelf resides at Point-of-Purchase, POP, getting the eShelf to engage with the customer and their smart device at the purchase decision point is one of the best places to influence their purchasing decision. Google Glass or any smart head-worn device will be an excellent shopping tool and product management tool to interact with the eShelf. It will keep your hands free to interact with the products on the eShelf while providing an additional heads-up display.

Aligning the product on the shelf with its price is a key function of the shelf edge. The easiest and least expensive method of achieving this alignment goal for the eShelf is to use cameras and pattern recognition software. Cameras can take video of the shelf edge and then the images can be run through pattern recognition software to determine the number and location of the products on the shelf. The shelf images can come from mobile cameras on smart mobile device like smartphones, tablets, Google Glass or Apple Watches to name a few. Cameras can also be placed around the store to record the product availability on the eShelf. Cameras can also be included in the eShelf to determine product stock availability on the other side of the store aisle. Images of the eShelves/products received by mobile cameras are the most desired image data because that indicates that the customer is interacting with the eShelf. The management and calculations from all the video feed images will require immense computing power, which is much more suited for a store's server system or cloud computing than a mobile phone or an eShelf. Using camera images to track product stocking and location on the eShelf and in store will provide the store and the customer with three-dimensional rendered images of all the products throughout the store. Knowing the status of the products on the self at any point in time creates a database of product information that is very advantageous for shoppers, merchandisers and store owners. The product location data will allow for many software applications to run on both the eShelf and mobile devices to help the customer shop, help the merchandiser market and sell their products in stores, and help the stores stock, manage and sell the products on their shelves.

### BRIEF DESCRIPTION OF THE DRAWINGS

FIG. 1 shows paper based pricing labels.

FIG. 2 shows a printer that prints a color adhesive backed label.

FIG. 3 shows monochrome electronic segments addressed electronic shelf labels.

FIG. 4 shows printed colored labels for eye-catching and to provide more clear information.

FIG. 5 shows segment-addressed electronic shelf labels with different monochrome colored liquid crystal regions.

FIG. 6 shows matrix-addressable electronic shelf labels using black-and-white electrophoretic material and red-black-and-white tri-pigments.

FIG. 7a schematically illustrates an eShelf.

FIG. 7b schematically illustrates an eShelf with products.

FIG. 8 schematically illustrates an eSheet LCD panel.

FIG. 9 schematically illustrates a cross-sectional view of an eSheet.

FIG. 10 schematically illustrates a color eSheet LCD.

FIG. 11 shows photographs of red, yellow, green, and blue cholesteric LCDs formed using eSheets.

FIG. 12 shows photographs of grayscale images written in blue and yellow cholesteric LCDs formed using eSheets.

FIG. 13 schematically illustrates the three different phases of a cholesteric liquid crystal material used during addressing the display.

FIG. 14 graphically represents a cholesteric liquid crystal ‘bathtub’ curve.

FIG. 15 shows photographs of 3-stacked-panel color eSheet cholesteric LCD.

FIG. 16 shows a photograph of a full-color, grayscale eSheet cholesteric LCD.

FIG. 17a schematically illustrates a flat plate used in an eSheet forming process.

FIG. 17b schematically illustrates a release layer applied to the flat plate shown in FIG. 17a.

FIG. 17c schematically illustrates a transparent silver nanowire coating applied to the release coated flat plate in FIG. 17b.

FIG. 17d schematically illustrates rolling the silver nanowires flat down onto the flat plate.

FIG. 17e schematically illustrates attaching wire electrodes to the rolled silver nanowires on the flat plate.

FIG. 17f schematically illustrates different cross-sectional views of the wire electrodes shown in FIG. 17e.

FIG. 17g schematically illustrates laser scoring the transparent silver nanowire coating.

FIG. 17h schematically illustrates the patterned electroded structure from FIG. 17g.

FIG. 17ia schematically illustrates electrically coated triangular-shaped wire electrodes connected to transparent conductive electrodes then overcoating with a hard nanofill.

FIG. 17ib schematically illustrates applying the eSheet substrate material onto the patterned electrode structure of FIG. 17ia.

FIG. 17ic schematically illustrates flipping the eSheet in FIG. 17ia upside down and forming wire cloaking globes on the wire electrodes.

FIG. 17id schematically illustrates flipping the eSheet in FIG. 17ia upside down and applying the eSheet substrate material onto the patterned electrode structure.

FIG. 17ie schematically illustrates applying the eSheet substrate material onto the patterned electrode structure of FIG. 17h.

FIG. 17j schematically illustrates the removed eSheet from the flat plate of FIG. 17i.

FIG. 17k schematically illustrates the final wire-based eSheet.

FIG. 18a schematically illustrates a transparent silver nanowire layer with a heavy silver nanowire on one side applied to a flat plate.

FIG. 18b schematically illustrates rolling the silver nanowires in FIG. 18a down flat onto the flat plate.

FIG. 18c schematically illustrates the flattened silver nanowires on the flat plate after the rolling step of FIG. 18b.

FIG. 18d schematically illustrates laser scoring the transparent silver nanowire coating into electrode stripes and patterning the heavy conductive coating into lead traces from the electrode stripes to chip bonding areas.

FIG. 18e schematically illustrates the patterned electroded structure from FIG. 18d.

FIG. 18f schematically illustrates bonding the driver chip to the heavy conductive coated lead traces of FIG. 18e.

FIG. 18g schematically illustrates placing isolation films over the electrode area.

FIG. 18h schematically illustrates attaching the data ribbon cable wire electrodes to driver chips.

FIG. 18i schematically illustrates applying the eSheet substrate material onto the patterned electrode structure and bonded chips of FIG. 18h.

FIG. 18j schematically illustrates the removed eSheet from the flat plate of FIG. 18i.

FIG. 18k schematically illustrates the final eSheet with embedded driver chips connected the short transparent conductive electrode stripes facing upward.

FIG. 19a schematically illustrates the patterned electrode structures on their flat plates of FIGS. 17h and 18h sandwiched around a sheet of substrate material.

FIG. 19b schematically illustrates the double-sided eSheet stack of FIG. 19a molded together.

FIG. 19c schematically illustrates the double-sided eSheet stack of FIG. 19b with the flat plates to remove.

FIG. 20 schematically illustrates a color cholesteric LCD using two eSheets and two dual-eSheets for the center.

FIG. 21 schematically illustrates the color cholesteric LCD in FIG. 20 in a single stack.

FIG. 22a schematically illustrates liquid crystal spacers with an adhesive coating.

FIG. 22b schematically illustrates the liquid crystal spacer in FIG. 22a resting between eSheets.

FIG. 22c schematically illustrates how the soft adhesive on the LC spacers can flow and allow the eSheets to squeeze down to a cell thickness equal to the actual spacer thickness.

FIG. 23 shows a photograph of crisscrossing wire electrodes used in the projected capacitive product sensor.

FIG. 24 shows a photograph of diamond-shaped conductive pads electrically connected to the crisscrossing wire electrodes to increase the surface capacitance in the projected capacitive product sensor.

FIG. 25a schematically illustrates a resistive eSheet weight sensor pad.

FIG. 25b schematically illustrates a resistive eSheet weight sensor pad with wide electrodes.

FIG. 25c schematically illustrates the force changing the resistance at each tactel in the weight sensor pad of FIG. 25a or 25b.

FIG. 25d schematically illustrates the force changing the resistance at each tactel in the weight sensor pad with a diode at each pixel.

FIG. 25e schematically illustrates a diode material deposited on the wire electrode to limit the current to flow in one direction.

FIG. 25f schematically illustrates a cross-section of a pn diode applied to the wire scan electrode with the piezoresistive material sandwiched between it and the data electrode.

FIG. 26a schematically illustrates a capacitive eSheet weight sensor pad.

FIG. 26b schematically illustrates the force changing the capacitance at each tactel in the weight sensor pad of FIG. 26a.

FIG. 27 shows photographs of a reflective 19.2″×19.2″ eSheet LCD with 192×192 pixels with a font size test image being written on the surface while it is bent at about a 5 inch radius.

FIG. 28 shows a photograph of a pressure-sensitive eSheet cholesteric liquid crystal display with the image “For Sale” mechanically written into the display's reflective liquid crystal interface.

FIG. 29 shows photographs of pressure-sensitive yellow cholesteric liquid crystal LCDs showing the effect of the background color on the color of the reflective image.

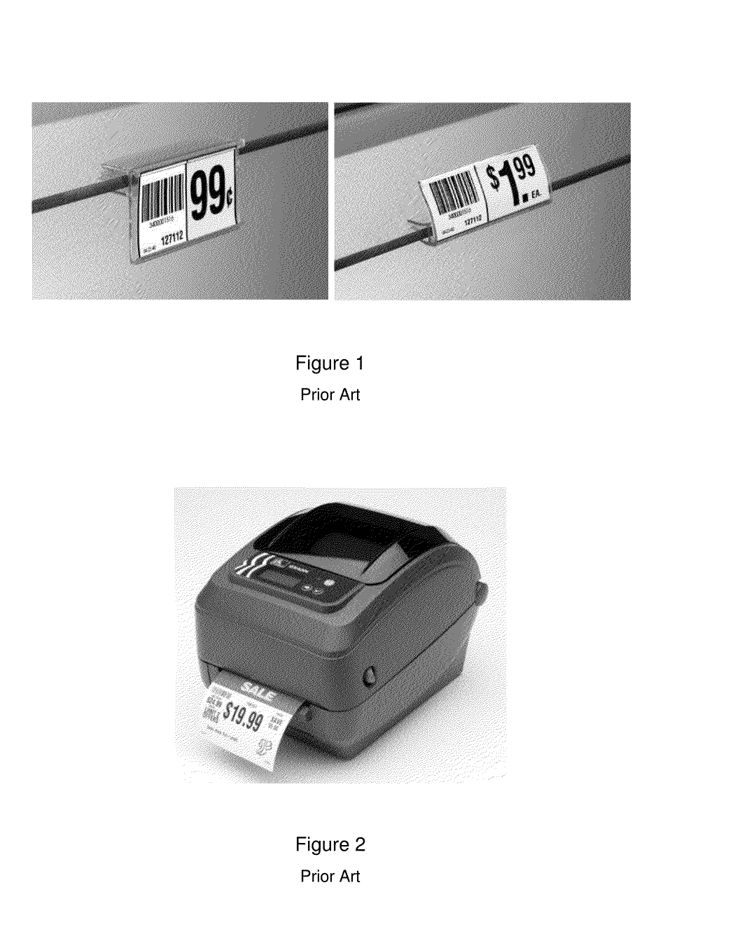

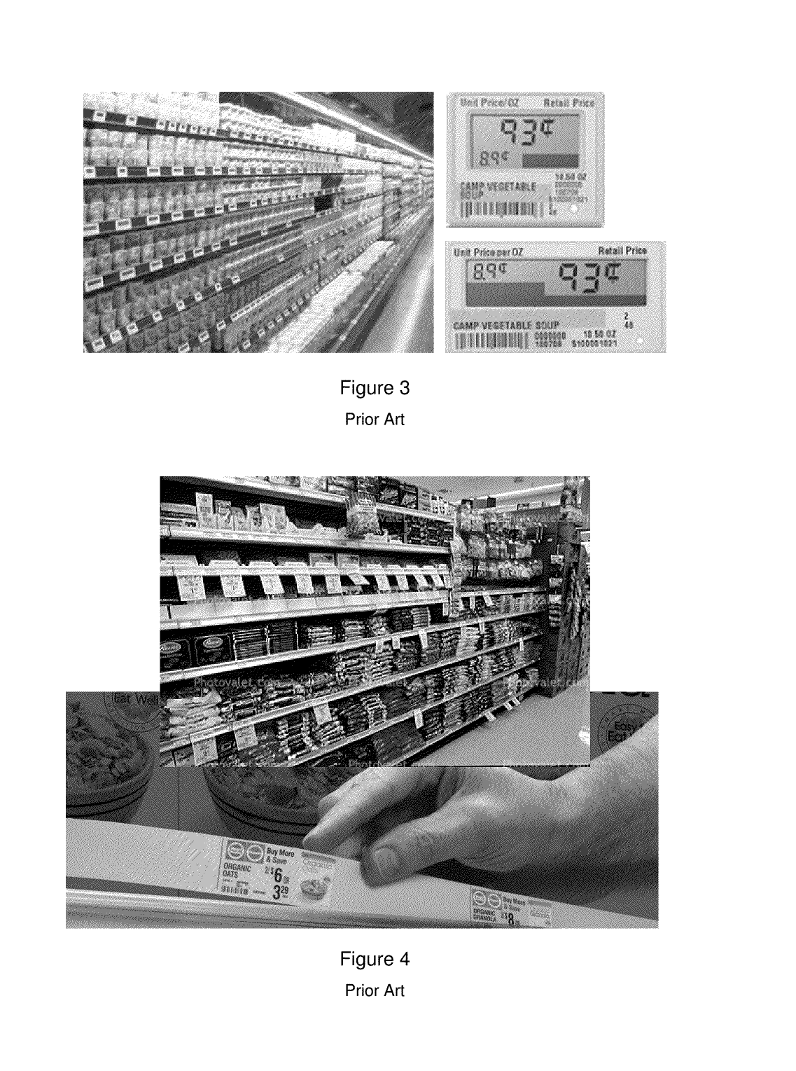

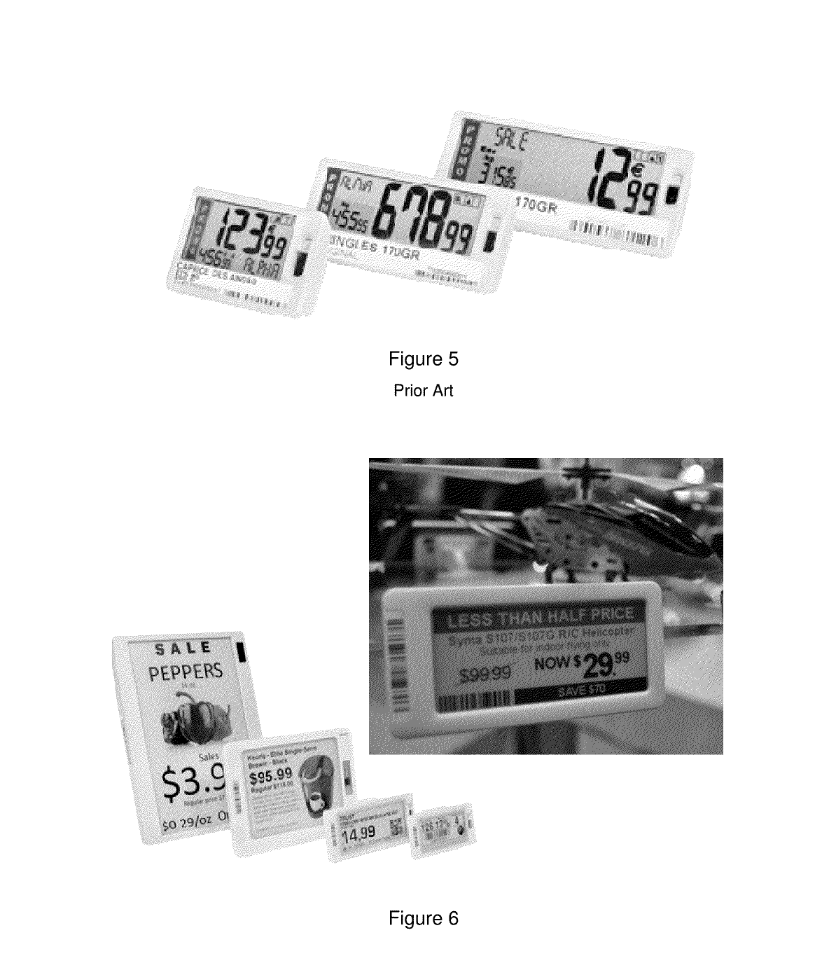

### DESCRIPTION OF THE PREFERRED EMBODIMENT

The cholesteric eSheet LCD can be used solely as an electronic shelf label (ESL). Presently the electronic shelf label market is composed of black-and-white LCDs and black-and-white, and soon to come black-red-and-white electrophoretic displays. The reflective eSheet LCDs will provide a color solution for the stores to better communicate to their customers. A colored electronic shelf edge display will allow the stores to differentiate their products and make an eye-popping attractive shelf edge. A product sensor pad can be attached to the display to complement the color shelf edge display. These two different products (electronic shelf display and the product sensor pad) could be molded into one unit. The product sensor pad would rest on the shelf and the display would attach to the edge of the sensor pad at about a 90° angle. Therefore, the display would hang off of the edge of the sensor pad and cover the edge of the shelf. The really-long, high-resolution, reflective, ‘no-power’, full-color, LCD can share the same electronics with the product sensor pad and can be one solid unit with a battery, solar cells, electronics and wireless communication. This would make installations a breeze. Just clean off the shelf. Slide the eShelf onto the shelf. Place the eShelf in stocking interactive mode. Fill it with merchandise. Place the eShelf in customer interactive mode. Let the customer shop and interact with the eShelf.

The usage model for the eShelf is simple. Imagine yourself in a grocery store and when you turn the corner along all the shelf edges are continuous full-color LCD pricing and information displays ready to interact with you. You have previously set up your shopping list on your smartphone and decided how you would like the eShelf to interact with you. As you step forward down the aisle the displays, they come alive and start interacting with you. One setting that I will have on my eShelf is that purple boxes with navy blue dots will appear around the product labels that are on my shopping list on my smartphone in my pocket, as I turn down the aisle. After I remove the product from the shelf a green arrow will appear on the eShelf pointing in the direction of the next product on my smart shopping list in my pocket on my smartphone, as the last product gets crossed off the list. An autonomous, interactive, full-color LCD under every product in the store would be like having a shopping buddy for every product.

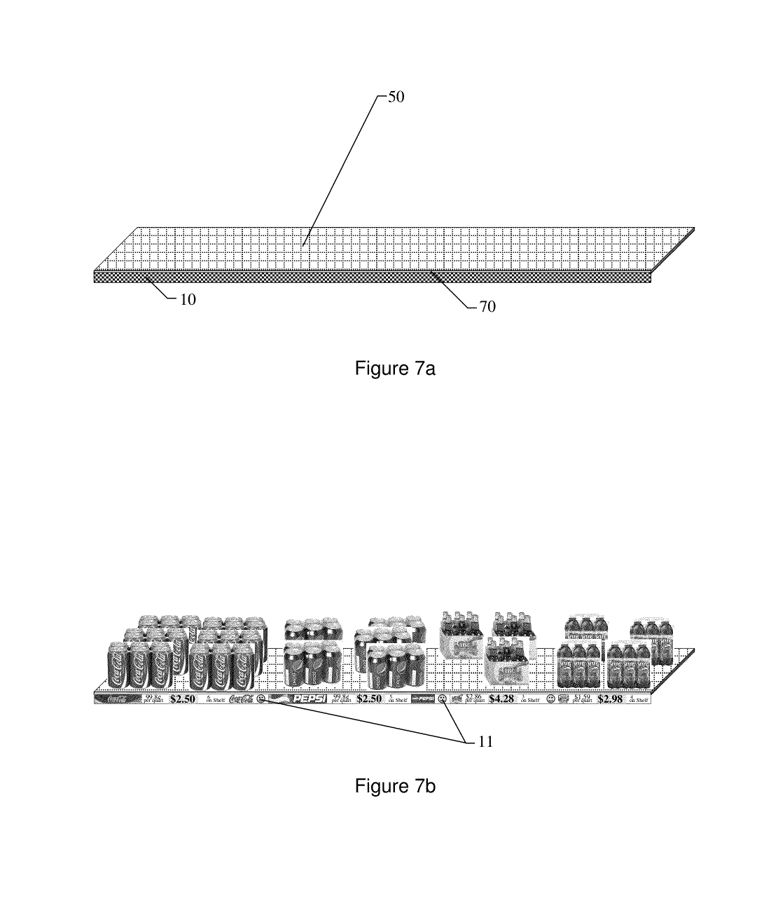

The eShelf, shown in FIG. 7, is composed of a very-long, reflective, full-color, liquid crystal display (LCD) 10 attached to a shelf product sensor pad 50. FIG. 7a is a general schematic of the eShelf. FIG. 7b is a schematic of what the eShelf could look like with products resting on the sensor pad. The product's pricing and stocking information can be displayed on the LCD directly below the products. The store separation character, shown in FIG. 7b as a yellow smiley face 11, can be displayed on the LCD between the product's information. Individual stores can have their own logos 11 displayed on the eShelves between products. The eShelf can receive its power from small solar cell strips at the top of the display 70 or the solar cell can reside behind the LCD 10, which in turn would serve as the back absorber for the reflective LCD. The eShelf has antennas in the display/pad sensor system to both sense products and wirelessly communicate to nearby customers and to the store interface. The true success of the eShelf will depend on the countless apps that will run on or interact with the eShelf to help customers make their purchasing decisions.

The eShelf could contain a shelf product sensor pad 50 that senses products placed on the shelf, resting on the shelf, or removed from the shelf. The shelf'sensor pad 50 could record many aspects of the product, such as, the product's size, location, and number of products on a shelf, the weight of the products, temperature and can talk to any RFID or NFC tags. This information could be electronically displayed on the attached reflective color LCD price rail, or it could be wirelessly transmitted to the store's central database. This cataloged information could be used to find products, stock shelves and manage the whole purchasing process. These eShelves could even have a low-power Bluetooth link (NFC, or other short range, low power communication link) to all nearby customers' smartphones. The wireless eShelf communication link could provide product information such as price, location on the shelf and in the store, number in stock and on shelf, picture of product, UPC code, ingredients, health facts, promotions, digital coupons, and just about anything else a customer may be interested in knowing in their 21^{st} century supersmartmarket.

Key to making the eShelf possible is to use conductive wires as part of the addressing electrodes in the display. The conductive wire electrodes allow for addressing and sensing of very long lines. The long eShelf can also be manufactured using a very simple, low-cost manufacturing process. The low-cost wire-based displays use a bistable, reflective, colored cholesteric liquid crystal materials to build “no power”, full-color LCDs with perfect image retention. The key to the eShelf technology is that the wires used to build the electrode structure are highly conductive. The wires provide for the addressing and sensing of very long lines, hence, enabling large displays and sensors. Assuming a typical aisle in a store is 52 feet long then eShelves can be fabricated to cover the entire 52 foot long shelf. That is a 2 feet by 52 feet wired sensor mat can be fabricated and attached to a 1½ inch wide reflective full-color LCD that can be addressed along the entire 52 foot display. These long eShelves will allow for 100's of SKUs or products on a single eShelf. Being able to place, sense, and display many products on a single eShelf'solves the problems of the “electronic price rail” and makes it an economically viable solution. Typical display solutions at price rail require one display for every product. Therefore, all of the components to make the display and to communicate to the store are required for every electronic shelf label in the store. The high aspect ratio eShelf LCDs solve this problem by being able to place multiple products on a single display. Therefore, if a store has 90,000 products, the old system requires 90,000 displays. If the eShelf can house on average 100 products per shelf, then the new eShelf will only require 900 eShelves to display every product in the store.

From a business standpoint the eShelf has a targeted audience. The lion's share of the installations are held by a few companies (e.g., Wal-Mart, Kroger, Cosco, Target, Safeway, Lowe's, Home Depot). Supplying Wal-Mart alone with eShelves could be over a billion-dollar business. A key advantage of the price rail display in the eShelf is that it is effectively a “Point of Purchase” (POP) display. In advertising, these POP displays are the most effective place to grab the customer's attention, right as they are making their purchasing decision. In addition to large installments, there are many gas stations and shops with merchandise to be eShelved. These eShelves could be “sold” through a rental business. Renting the eShelves will provide the maximum amount of return over the life of the product while lowering the bather to entry for many customers.

One very important aspect of the eShelf rollout is to develop a system that can interact with the customer's second brain, their smartphone or Google Glass or Apple Watch. Interacting with a customer's smart mobile device will help them find products, get deals and shop. It will allow them to receive product information, receive recipes, receive promotions and digital coupons, and just about anything else a 21^{st} century customer may be interested in knowing or obtaining from their 21^{st} century supersmartmarket. Interacting with mobile devices will also help the staff check and stock shelves.

There has been a lot of advancement in mobile computing devices. One mobile device that has been getting renewed interest is a mobile headset. Electronic headsets with integrated displays have been around for many years, however, mostly for military and gaming applications. Google Incorporated has developed consumer-based headset device called Glass. Google's Glass is essentially a present day smartphone in glasses minus the phone. With the proper programming these mobile smart headset devices could be used for an interactive shopping experience. The smart headsets could be programmed to interact with the eShelves. The smart mobile device and the eShelf could wirelessly share their information, both product and sensor.

Aligning the product on the shelf with its price is the key function of the shelf edge. The easiest and least expensive method of achieving this alignment goal for the eShelf is to use cameras and pattern recognition software. If customers use their mobile devices and provide stores with the information in images of products on the shelf then the expense of the sensor pad virtually disappears. The “What products are on the shelf and exactly where are they located?” questions can be achieved using cameras with position and direction sensor, and pattern recognition software. The best place to receive images of products on the shelf is from cameras on mobile smart devices. The reason that mobile images are the best place is because the customer is in the store and is interacting at the shelf edge. Images of products on the shelf can also be obtained using cameras in the mezzanine overhead or in key shelf viewing locations around the store. Stationary cameras provide a constant data stream of products and the eShelf edges.

Cameras can also be built into the eShelf to sense customer behavior and interaction with the eShelf. Cameras from one eShelf can sense the customer interaction with an eShelf on the other side of the aisle and wirelessly communicate this interaction with the other eShelf. The eShelf on the other side of the aisle can use its display to interact with the customer. The cameras in the store can use pattern recognition software and detect when a customer can see a particular shelf. If the eShelf in their vicinity and has products on their shopping list, then the eShelf becomes active and starts interacting with the customer.

Cameras integrated into the eShelf can also visually sense the status of the products on the opposite side of the aisle. This product information can be wire or wirelessly transferred to the eShelves on the other side of the aisle and to the store's central database. A key part of making this camera/eShelf'system work is knowing the exact locations of the cameras and the eShelves in the store. Cameras could be molded into the right angle connector between the display and the pad. The cameras can also be located behind the display glass. The cameras could also be located at the backside of the eShelf pad so that they are pointing out from back within the shelf to view products on the eShelf. Integrating a compasses and a global positioning system (GPS) into each eShelf will allow for the exact location, position and direction of each eShelf. The eShelf's electronics could be similar to that of a smartphone, which tracks its exact location and direction in space. Knowing the exact location and direction of each eShelf will be essential when categorizing the exact location of all the products in the store.

One of the first things that any shopper does is build a list of the products that they need to purchase. This shopping list could all be done electronically. There are many different ways to electronically build a shopping list. One way would be to take a picture of the product or the barcode with your smartphone and the product will show up on your shopping list. Another method would be to select a product found online and place it into your shopping list. Another method would be to scroll through products that have been previously purchased and copy them into the shopping list. These previously purchased items could be categorized in the search list in many different ways, such as: frequently purchased, alphabetical, categorized (meat, fruit and vegetables, frozen foods, snacks, clothing, cleaning, etc.). A fairly complete list of products that are traditionally purchased will be developed after several trips to the grocery store. Once the shopping list is completed, price and availability can be checked from local stores. Stores could offer customers special digital coupons to entice them to shop at their store. The shopper will know how much their shopping trip will cost and who will provide them the best overall price before they leave the house or office.

As a shopper enters the store their smart mobile device communicates to the store's central database. The items in their shopping list automatically arrange to the most efficient path through the store. Any digital coupons from the shopping list and any other special offers on products in the store could be transferred between the mobile device and the store. Special digital coupons could be offered to customers for products that are being discontinued or products that are reaching their expiration dates. Note that the rest of the shopping explanation assumes that the shopper is wearing Google Glass, however, a similar shopping experience could be achieved with a smartphone running video with overlays on the screen. As the shopper walks into the store, they could be guided to the first item on your shopping list using the screen on their mobile device. As the shopper looks up and down the aisle discount prices of items on sale could be overlaid on their screen. General price discounts could be in yellow and special price discounts targeted to that specific customer could be in red. If the store tracks the customer's general buying habits, then the store could provide the customer with a digital coupon for products not on their shopping list, but ones that they traditionally buy. These special coupons could stand out on the customer screen, such as by overlaying a red rectangle around the item. The eShelf could likewise outline the special item's pricing information with a red rectangle on the eShelf LCD. Once the customer is directed to their first item, they reach out and pick it off the shelf. The video from their Glass senses the choice and the store can offer the customer other promotions, such as buy a second and get ½ off. As the customer places the items in their shopping cart, the item is removed from their shopping list and the digital coupon is tagged to the mobile device. The shopper is then guided to the next item on their shopping list.

As the shopper looks at the shelf edge, the video of the price and products on the shelf can be analyzed. Note this analysis could be done by the store or the cloud using the mobile device's video feed. If any pricing errors on the shelf rail or any low or out of stock items are determined then the store staff could be notified. Customers that share their video feed for pricing and stocking information could receive special offers from the store. Staff could also wear Google Glass to check price, determine shelf'stock and to stock items. Wearing Google Glass while stocking items or scanning shelves will provide the store with data on the location of the products within the store and on the shelf and the present number of products on the shelf.

As the shopper finishes shopping and all of the items on the shopping list have been removed they enter the checkout line. All the products in their chart can also exist in their digital shopping bag. The store has recognized the shopper since she entered the store, helped her shop, and now automatically communicates all the items in her cart and digital coupons with the main store cash register and digitally transfers her bill to her smart mobile device and wishes her a nice day.

Google Glass or any smart head-worn device will be an excellent shopping tool and product management tool to interact with the eShelf. It will keep your hands free to interact with the products on the eShelf while providing an additional heads-up display. The eShelf is a fairly non-invasive display product that can behind scenes help the customer shop. Smart headsets, such as Google's Glass, could provide an interactive shopping experience in today's present-day supermarkets. Shopping with a smart headset could be done without any electronic displays on the shelf edge. Since Google Glass has its own “heads-up” display the customer could use it as the interactive display. There are customers that love the full interaction and for those customers there is Google Glass and with an interactive eShelf they could participate in managing and interacting with the store and products on the eShelf. Other non-technical customers can use the color LCD shelf displays to better discern the product information and more easily locate products on the shelf.

The eShelf cholesteric liquid crystal display has perfect color image retention using NO-power to display an image and only slight power to update the image. This low display power addressing only places a small burden on the eShelf's power. The other power advantage is that the product sensor does not have to be constantly running. The product sensor can run similar to writing images on the reflective bistable LCD. The entire surface of the sensor pad or a section of the pad can be read and data stored and analyzed, then it can “go to sleep”. This display/sensor combination could easily run off of a battery. The largest power load will be the wireless communication link. One issue with running autonomous eShelves would be constantly recharging the batteries. One simple recharging method is to attach a solar cell to the eShelf to provide power to the battery. The easiest method to integrate the solar cells into the eShelf is to attach a thin row of solar cells across the top of the display. The solar cells along with the imaging sensors can be included in the molded joint between the display and the sensor pad. The second solar cell option has a twist to the reflective LCD. The LCD uses a cholesteric liquid crystal to Bragg reflect one handedness of a narrow color. The remaining light gets forward scattered through the display to get absorbed by the back “black” absorber. If this back “black” absorber is a solar cell then the absorbed light can be turned into electricity to power the eShelf. Therefore, the solar cell can be placed behind the reflective LCD to absorb transmitted light and convert it to power for the eShelf. Because the eShelf will be indoors and the solar cell will be behind the LCD, the intensity of light will be low. It would be beneficial if the solar cell is composed of a direct bandgap semiconductor. Direct bandgap semiconductors are more efficient in lower light intensity levels. Another way to power the device is to use an area in the product sensor pad as a wireless charging connection. This is similar to a transformer and can use a technology similar to what is presently being used to charge computers and even electric vehicles. However, the power would still have to be supplied by the store at shelf. Therefore, there is little to no advantage of inductively transferring power to the eShelf. The only advantage would be a safety advantage, which can be overcome by plugging the eShelf into a low voltage DC outlet. Adding a low-power microcomputer into this autonomous eShelf to do all the addressing, sensing, crunching numbers and communicating and the eShelf will be the ultimate addition to 21^{st} century store.

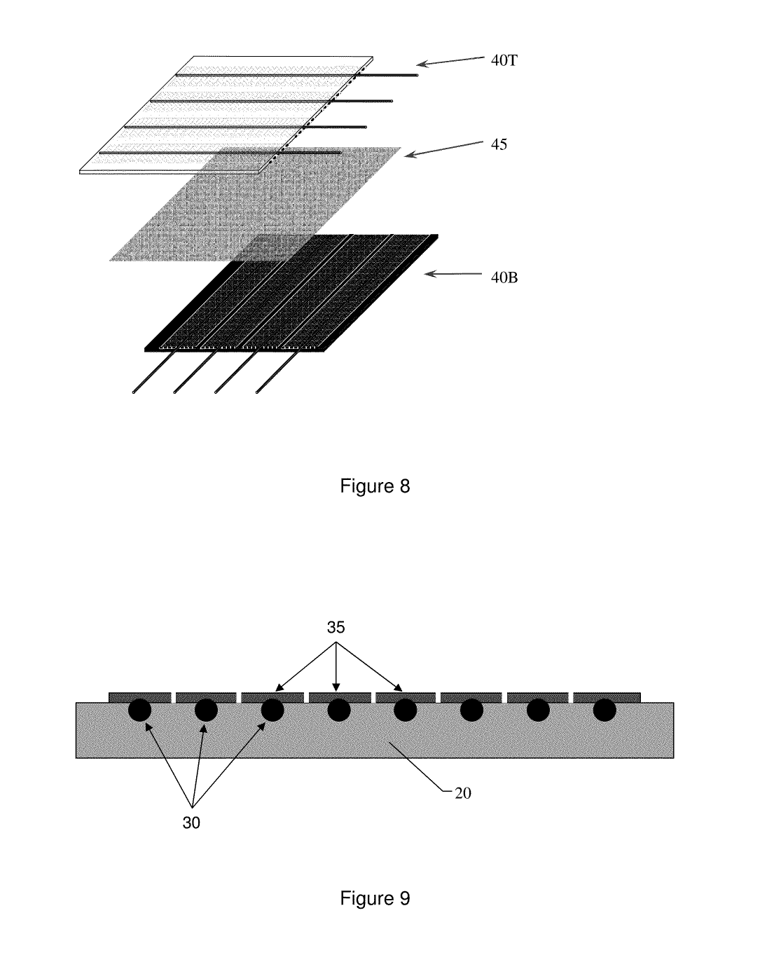

For the display to be a successful part of the eShelf, it has to be very energy efficient and it has to display color. These two key parameters lead to one solution for the electro-optic material, a cholesteric liquid crystal. A cholesteric liquid crystal display is both reflective and bistable, therefore requiring no power to display an image. The cholesteric liquid crystal electro-optic material Bragg reflects circularly polarized light across a narrow wavelength window creating specific colored reflective light. The cholesteric liquid crystal material has a voltage addressing threshold, therefore it does not need a transistor at each pixel and can be fabricated by simply sandwiching a cholesteric liquid crystal material 45 between two orthogonal electroded substrates 40T and 40B, as shown in FIG. 8. A key part of the present invention is to use wire electrodes to form part of the electrode substrates. These wire-based electrode substrates or eSheets have been covered in detail in U.S. Pat. Nos. 8,089,434, 8,106,853, and 8,166,649, which are included herein by reference. The patents explain the electroded sheets (eSheets), which are thin flexible (rollable) polymer substrates 20 with embedded wire electrodes 30, which are electrically connected to patterned transparent conductive stripes 35, as depicted in FIG. 9. The wires 30 in the eSheet carry the electric current along the length of the display and the transparent conductive stripes 35 spread the voltage across the pixel width. ESheets are simply formed by embedding the wire electrodes 30 into the surface of a thin polymer substrate 20 and the transparent conductive coating is solution coated and patterned. The coated and patterned eSheets are then run through a final flattening process to achieve the tight surface flatness specification (<0.5 μm). There are virtually no size limits on the wire electrodes or on the process of embedding them into the polymer sheets allowing for the fabrication of extremely large displays and eShelves.

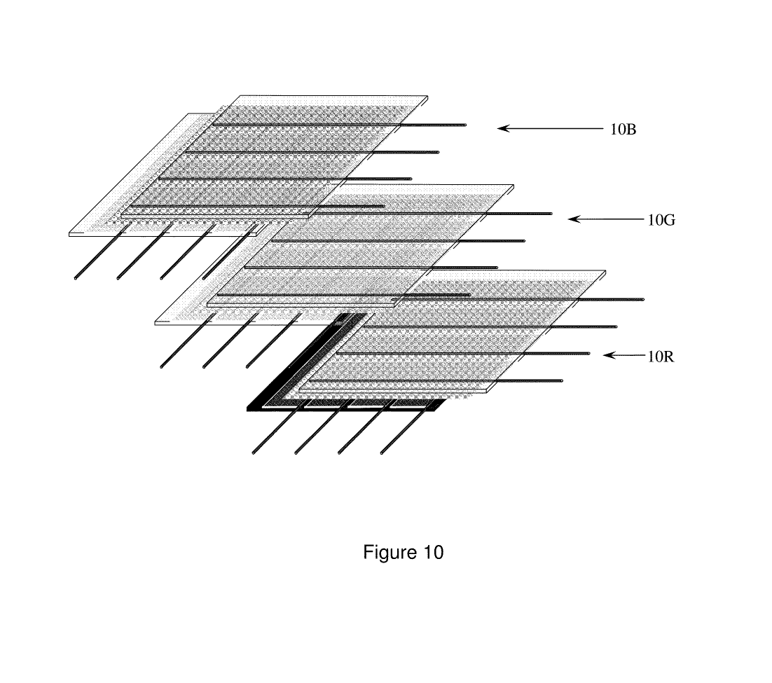

The only effective way to create a reflective, full-color display is by stacking three red 10R, green 10G, and blue 10B color panels, one on top of the next, as depicted in FIG. 10. A three-layer color stack is, in theory, capable of reflecting the entire light incident on the pixel, as opposed to placing the three colors side-by-side, in a horizontal plane, where ⅔ of the incident light is lost. The three primary color stacking method works for the cholesteric liquid crystal materials because they can be modulated between a transparent (forward scattering) state and a reflective colored (red, green, or blue) state. Breaking up the display's color vertically will allow the entire light incident on the display to be reflected achieving the most vibrant color displays possible. If both right and left twisted cholesteric liquid crystal materials are used in each panel then the display will reflect over 70% of the incident light across the entire color spectrum, while requiring no power to display the image.

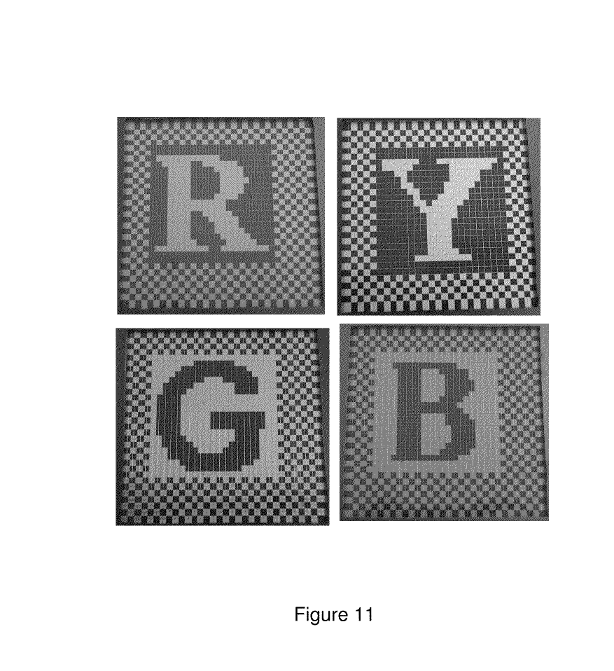

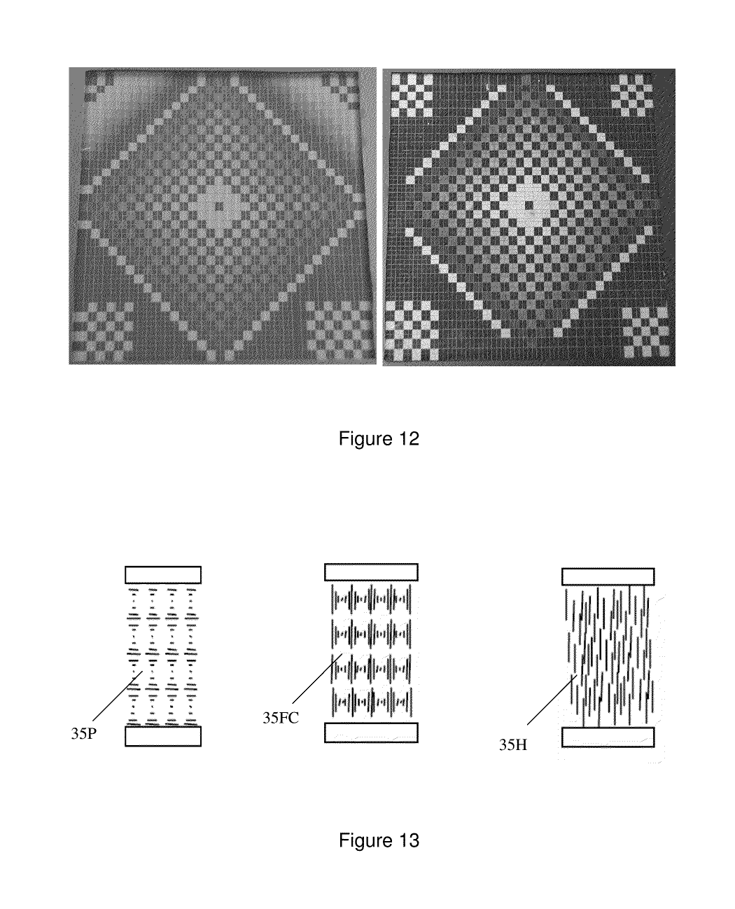

Applying the proper voltage waveforms to the wire electrodes in the eSheet switches the cholesteric liquid crystal between a reflective colored state and a forward scattering transparent state at each crisscrossing wire electrode or pixel in the LCD. Cholesteric LCDs have two bistable states: 1) a planar state 35P where the centerline of the twist in the helix structure is normal to the plane of the substrate and the cell appears reflective, and 2) a focal conical state 35FC where the centerline of the twist in the helix structure is in the plane of the substrate and the cell is transparent (or forward scattering), as depicted in FIG. 13. If the rear electroded sheet 40B (eSheet) is black and light absorbing, then the cholesteric liquid crystal display image will be the reflective color of the filled cholesteric liquid crystal material on a black background, as shown in FIG. 11. The reflective color from the cholesteric liquid crystal material can be varied from fully reflective to totally transmissive allowing for full grayscale, as shown in FIG. 12. Note that the images in FIGS. 11 and 12 are monochrome images using a single cholesteric liquid crystal panel depicted in FIG. 8. Note that the bright lines between pixels (standing out mostly in the black areas in FIG. 12) is a result of scoring the transparent conductive electrodes with a razor blade. The razor blade scored a wide isolation path through the transparent conductive electrode, therefore, there is no transparent electrode above or below the liquid crystal at these lines to switch the liquid crystal material. The bright lines will disappear when the transparent electrode is laser scored or printed directly to reduce the isolation width between adjacent transparent conductive electrode stripes.

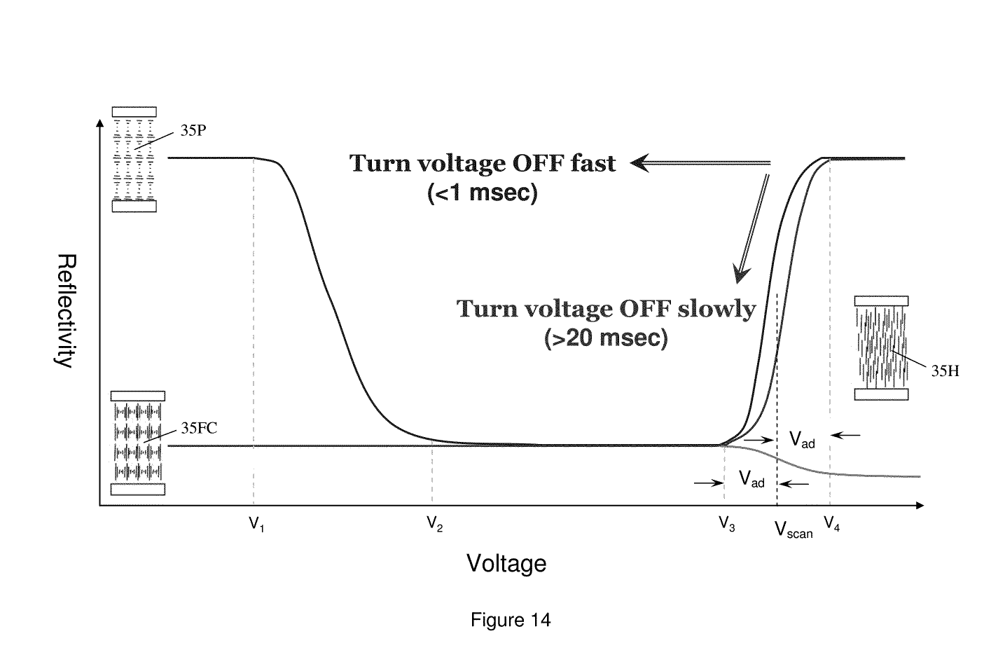

The reflective cholesteric LCD can be switched between a reflective “Planar State” and a forward scattering “Focal Conic State”. The cholesteric liquid crystal molecule twists like a corkscrew, as shown in FIG. 13. The twisting chiral center molecule has twisted nematic “paddle like” liquid crystal molecules attached to the chiral molecule. The twist length or pitch of the chiral molecule with attached nematic liquid crystals determines the wavelength of circularly polarized light that gets Bragg reflected. The direction of the twist determines which handedness of circularly polarized light gets Bragg reflected. Therefore, when the twist of the helical cholesteric molecule is in the plane of the display 35P, light with the wavelength equal to the pitch, or one full twist rotation length of the cholesteric liquid crystal molecule, is reflected and all other wavelengths pass through the panel. The nematic liquid crystal part of the cholesteric molecule is polar, which means the ends are charged positive and negative. In the reflective Planar State 35P these charged liquid crystal ends lie in the plane of the display, therefore creating the minimum dielectric capacitance. As a voltage is applied across the cholesteric liquid crystal the electric field applies a force on these charged nematic ends. As the voltage is increased the charged nematic liquid crystals try to align to the electric field causing the cholesteric liquid crystal molecule to rotate 90° onto its side. Therefore, the twist of the liquid crystal molecule is now in the plane of the display, which is called the Focal Conic State 35FC, as shown in FIG. 13. This Focal Conic State 35FC is a stable state, which means that when the voltage is removed the cholesteric liquid crystal molecule stays lying on its side, and forward scatters light transmitting through the display panel. As the voltage is increased past the point where all the cholesteric liquid crystal molecules have rotated onto their side and are in the Focal Conic State 35FC, the cholesteric liquid crystal molecule starts to untwist. As the voltage is increased even higher the nematic liquid crystal molecules separate from their chiral host and align to the electrostatic field. This liquid crystal alignment state is called the Homeotropic State 35H and is shown in FIG. 13. The liquid crystal becomes very transparent in this state; however, the Homeotropic State is not stable. The AC voltage that most cholesteric liquid crystals switch between the Focal Conic State and the Homeotropic State is around 35 V. If the AC voltage across the cell is grounded (0 V), while the cholesteric liquid crystal molecule is the homeotropic state 35H, then the cholesteric liquid crystal latches to the Planar State 35P, as shown in FIG. 14. If the voltage is reduced slowly (over about 20 ms) or is reduced slightly below the onset of the Homeotropic State 35H then the cholesteric liquid crystal latches to the Focal Conic State 35 FC when the cell is grounded (0V). Therefore, to matrix address the display, a scan line AC voltage at the onset of the Homeotropic State voltage (V_{scan}) is applied to the first scan line while applying a small AC voltage (V_{ad}) to all the data lines. If the AC data voltage is in phase with the AC scan voltage then the effect of AC data voltage cancels out some of the scan voltage at the crossing pixel in the panel. Therefore, the pixel cell voltage is reduced to below the onset of the Homeotropic State (V_{scan}−V_{ad}). If the AC data voltage is out of phase with the AC scan voltage then the effect of AC data voltage across the pixel cell adds to the scan voltage placing the pixel at the crossed electrodes fully into the Homeotropic State (V_{scan}+V_{ad}). Once the AC conditions of the first scan line are set, the scan voltage of the first line is set to 0 V and the AC scan voltage is applied to the second scan row. The pixels in the first row then latch to either a reflective Planar State 35P or a forward scattering Focal Conic State 35FC depending on the actual cell voltage applied across the pixel during the first row scan. Controlling the specific AC data voltage on each individual data line during each row scan will set each pixel along that scan line at its grayscale color value. This row scan and data set voltages are applied to each subsequent row in the panel to write the image in the display. Note that the maximum AC data voltages (V_{ad}) are less than the onset voltage (V₁) to switch the cholesteric liquid crystal material from the Planar State 35P to the Focal Conic State 35FC. Therefore, the addressed rows are not affected by the data voltages during the subsequent row scans allowing the panel to be matrix addressed. This addressing is called passive-addressing because it does not require an active transistor or switch at each pixel. The switch or threshold is part of the liquid crystal material in the present addressing scheme, as shown in FIG. 14. Therefore, the cholesteric LCD can be simply addressed by applying voltages to orthogonal electrodes on both sides of the liquid crystal material.

The cholesteric liquid crystal is addressed to its grayscale state by applying a specific voltage for a period of time. The grayscale level is very sensitive to the time at voltage across the liquid crystal. This sensitive time at voltage condition is one of the reasons that very conductive electrodes are required to address long display lines. If the conductivity of the display lines are high enough to achieve high speed addressing then, instead of using an analog voltage to control grayscale, a high-speed time domain digital signal can be applied across the pixel during the frame addressing time to control the time at voltage and place the pixel at the desired reflectivity.

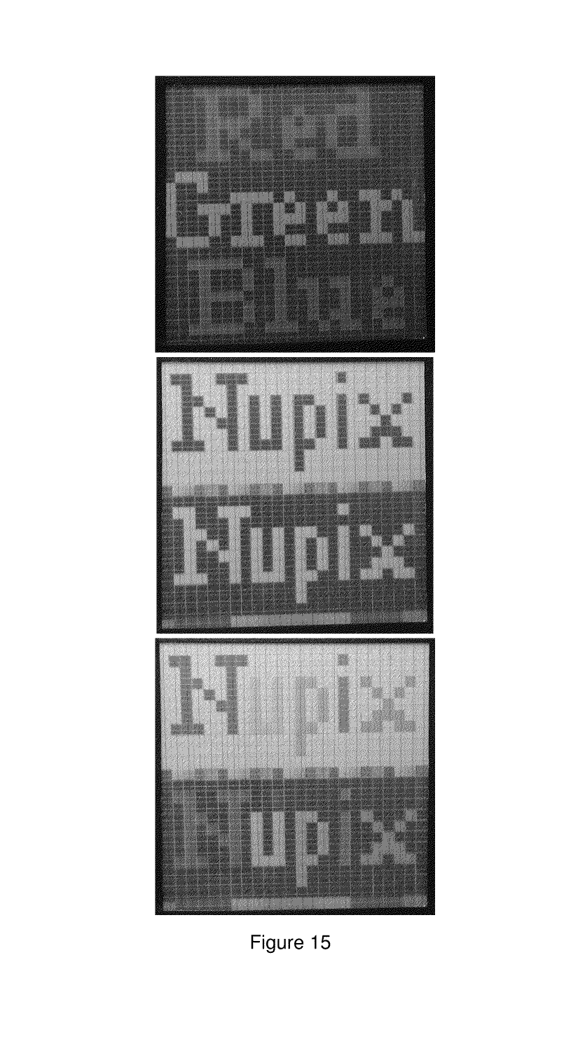

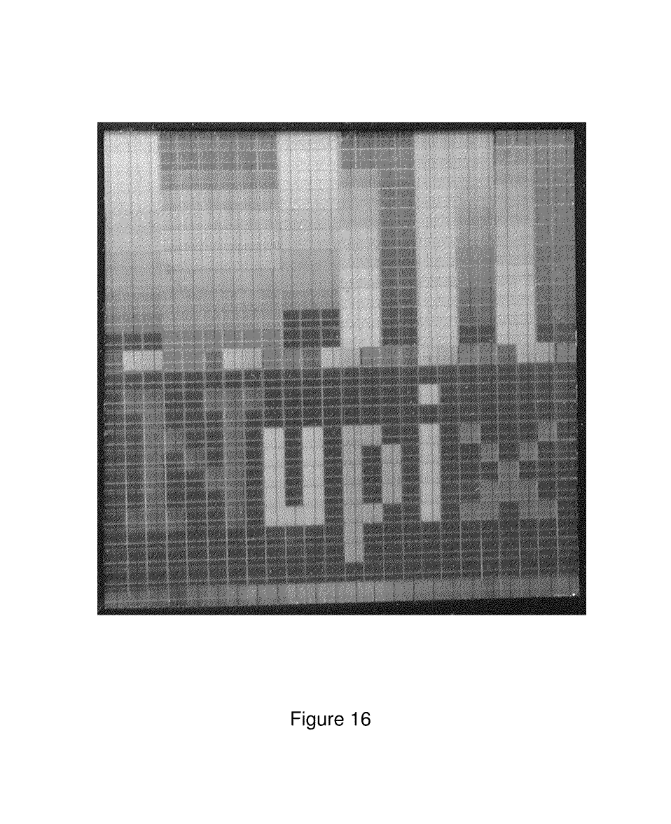

The above mentioned addressing scheme can be used to address a multitude of different cholesteric liquid crystal material color panels. Scan and data voltages of the different color panels will be slightly different due to the different cholesteric liquid crystal materials and optimum spacing of the cell gap. FIG. 15 shows eSheet LCDs fabricated by integrating red, green and blue cholesteric LC materials between orthogonal eSheets to form the three primary color stacks. Grayscale images can be written on the display using two different methods. The first method requires analog data drivers to set the variable cell voltages at each pixel in the scan line during addressing. This addressing method creates a one time addressing fast full-color grayscale image. The second method requires that any grayscale reflective pixel in the panel is written to the Planar State 35P during the initial scan. The voltage on the scan driver is then reduced and subsequent low voltage addressing scans switche the Planar State 35P pixels towards the Focal Conic State 35F. These driving schemes have the potential of creating many different levels of reflective intensity (grayscale) at every pixel in the panel. The color grayscale image in FIG. 16 was written using 8 shades of “gray”.

All of the above addressing schemes are line at a time addressing, which will not run video on large displays. However, the wires are very conductive and can switch the line voltages very fast. Using the above standard addressing scheme, eSheet cholesteric LCD panels were capable of being addressed at less than 3 ms per line. Note that this time is totally limited by the switching speed of the cholesteric liquid crystal material. There are dynamic addressing schemes that can switch each line in less than 1 ms. By using high-speed addressing, video windows will be capable along the eShelf.

The eSheet addressing substrates solve many problems with addressing and viewing very large color reflective LCDs. The wire electrodes in the eSheets are very conductive and can uniformly and very quickly bring the voltage of the line in the display up to its full potential. The cholesteric liquid crystal material has a high dielectric constant and a small cell gap, which leads to a high line capacitance (C). The resistance (R) of the electrode lines determines the time constant, τ(τ=4RC) or how long it takes to switch the voltage along the entire length of the line. A high time constant means that when a voltage is applied to the end of a line the far end takes a long time to come up to the same voltage. This non-uniformity in voltage along the line makes the LCD almost impossible to address. Resistive electrode lines do not allow for addressing of the cholesteric liquid crystal material. Even moderately conductive electrode lines fail to achieve high speed addressing and the grayscale level control in the LCD. Conductive wire electrodes solve these problems and allows for high-speed, grayscale addressing over very long lines (very large displays and very long eShelves). The wire electrodes are so conductive that they could even be used to address very high-speed liquid crystals such as ferroelectric liquid crystals and blue phase liquid crystals, which switch very fast (˜20 μs). The wires are so conductive that they have even been able to light a plasma in a plasma tube over six football fields long. A neon glow was achieved in the plasma tube by switching over 1,000 V in less than 1/10 μs, while driving several amps along the plasma tube wire electrodes.

The second major problem that the eSheets solve is the ability to create very large transparent addressing substrates. The reason the eSheets are so transparent is that the wire is used to carry the current (voltage) along the length of the line and the transparent conductive coating only has to spread the voltage over ½ of the pixel width. This very short charge spreading distance means that the transparent conductive coating does not have to be very conductive and can be very thin and transparent, thus creating a very transparent eSheet. Very transparent eSheet substrates will be required when fabricating three-layer colored stacked panels because light reflecting off of the bottom ‘red’ reflective LC panel will have to travel through a total of 10 electrode layers (5 down and 5 back out). If each electrode layer absorbs 15% of the transmitted light (like is traditional in standard ITO coatings), then only 20% of the incident red light will be reflected out of the display, if the LC layer could reflect 100% of the red light (which a single layer only reflects about 35%, therefore only 7% get reflected). If the eSheets are 95% transmissive then 60% would be reflected back out of the display (corresponding to a 21% if the LC reflects 35%). Therefore, very transparent eSheets are desired when fabricating color LCDs.

Except for tiling of small panels, no company has demonstrated a large-size reflective bistable color display. The reason for this lack of product is twofold. First, no one has built the equipment and process necessary to fabricate these displays because of the formidable costs. Traditional display equipment and processes cannot produce panels at a low enough cost to get large-scale acceptance and achieve the volumes necessary to justify the cost. There have been attempts to develop roll-to-roll processing to meet cost targets, but they have not succeeded in producing large panels. Initial roll-to-roll processing has focused on volume fabrication of small displays. Secondly, roll-to-roll processing uses printing processes to deposit coatings on plastic substrates to build the structure of the display. These printed conductors are not conductive enough to build large displays, which is the second reason for the lack of large reflective LCDs.

The electrodes in the display have to be sufficiently conductive to overcome the capacitive loading of the line and bring the entire line uniformly up to voltage. Conductivity is a function of the size of the conductor: the larger wire, the more conductive it is with less resistance. If the electrode lines are not conductive enough the display will have problems with addressing, image non-uniformity, slow addressing speeds, and inability to provide grayscale images. Indium Tin Oxide (ITO) is used by most of the industry for electrodes, but ITO alone is not a solution for making large, quality displays because it is not conductive enough. A passively addressed cholesteric LCD with transparent conductive electrodes is limited to about 12 inches of addressing length. Adding thin metal electrode lines to the ITO using expensive vacuum deposition processes will only work for medium size displays (up to about 30 inches). To make large high quality displays, a highly conductive electrode is required like a large cross-section conductive metal wire. The metal wires in the eSheet fit the bill and solve the conductive line addressing issue for large displays. Placing low cost metal wires in low cost polymer substrates using simple manufacturing process steps solves the cost issue. However, liquid crystal displays require extremely uniform, flat substrates. The eSheet manufacturing process creates extremely flat, uniform, conductive display panels.

The eSheet fabrication processes, covered in detail in U.S. Pat. Nos. 8,089,434, 8,106,853, and 8,166,649, which are included herein by reference, are simple and low-cost and create a very flat, highly conductive electroded panel. Unlike traditional manufacturing methods, eSheet manufacturing processes do not require any multi-level alignment steps, nor any etchants (like metal etching, patterning photoresist, acid and base cleaning large plates or sandblasting), nor any large area costly processing equipment (like photolithography systems, vacuum deposition systems, and precision silk screening). The eSheets are formed using fewer and simpler process steps with less complex and lower cost processing equipment. Fewer, less costly manufacturing steps lead to a much lower manufacturing cost.

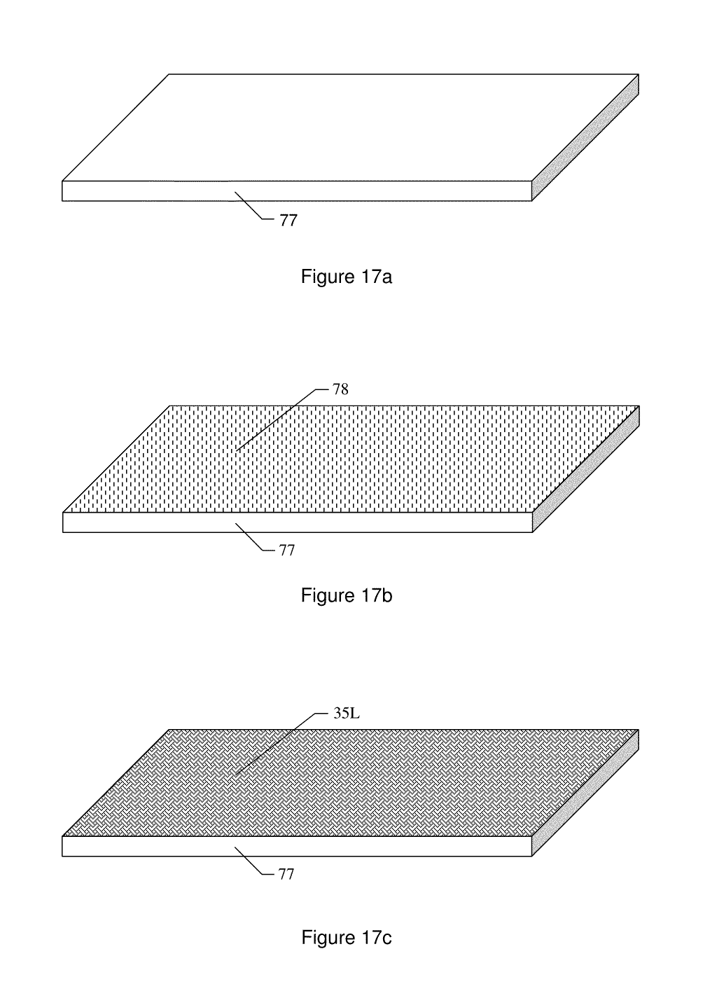

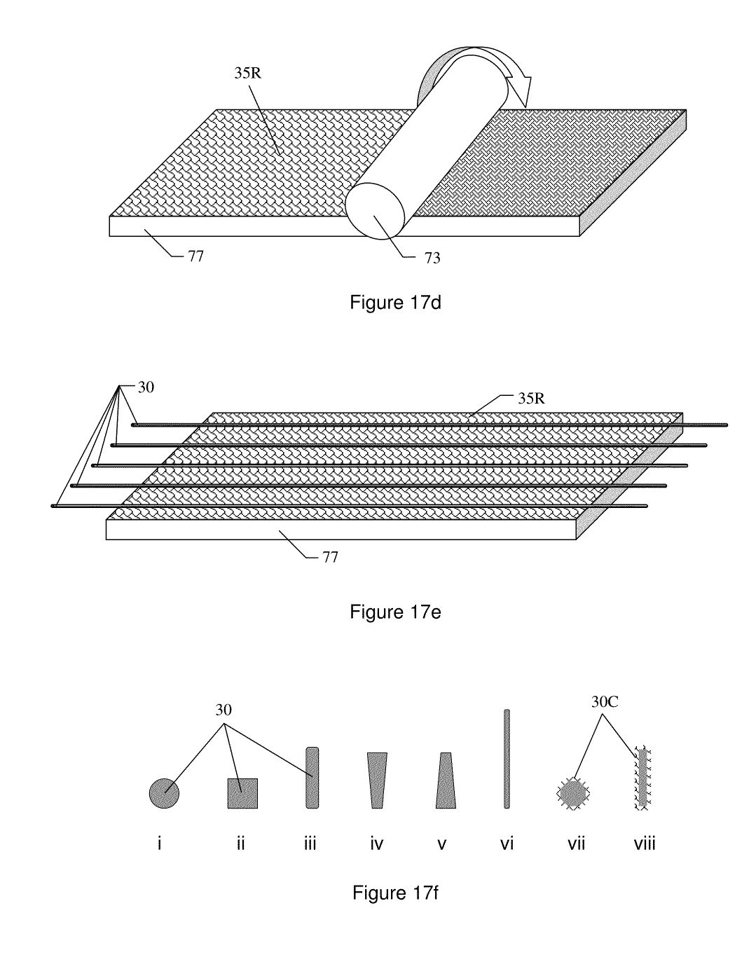

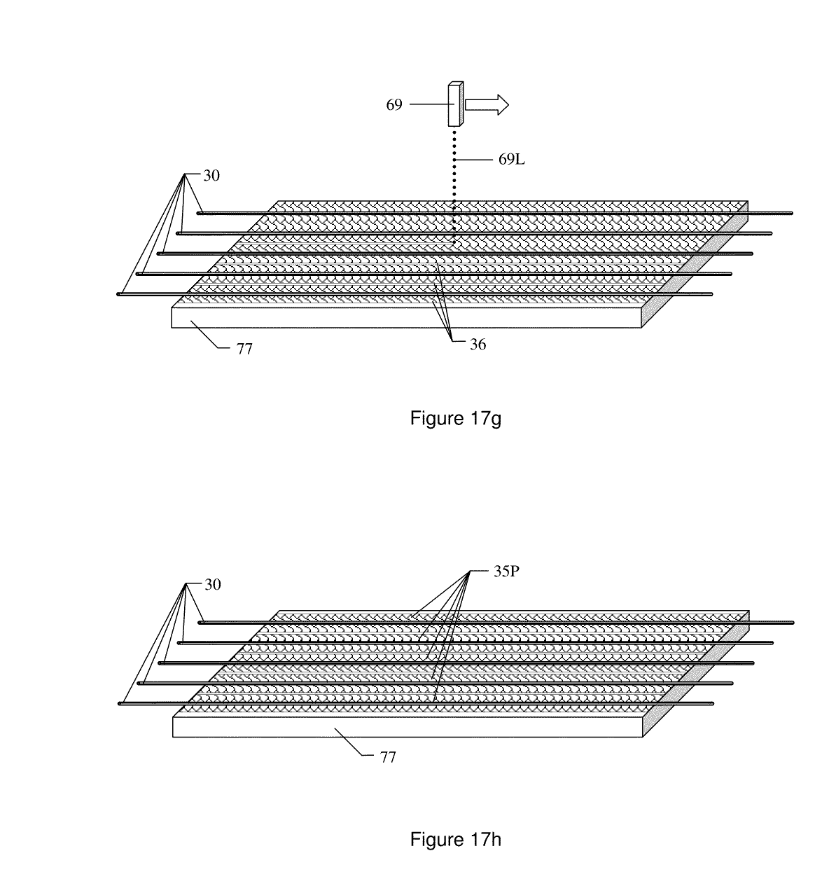

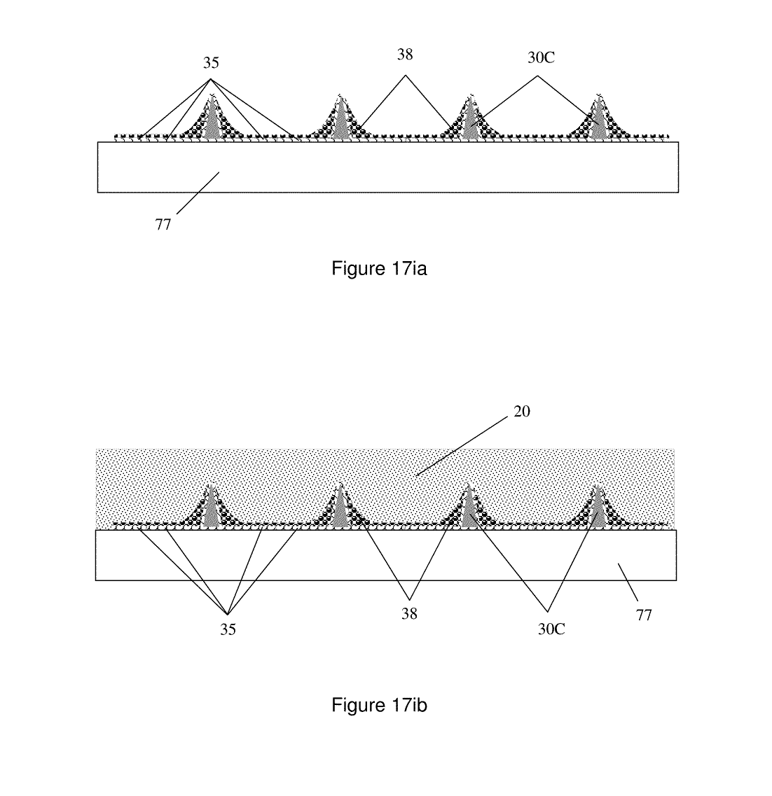

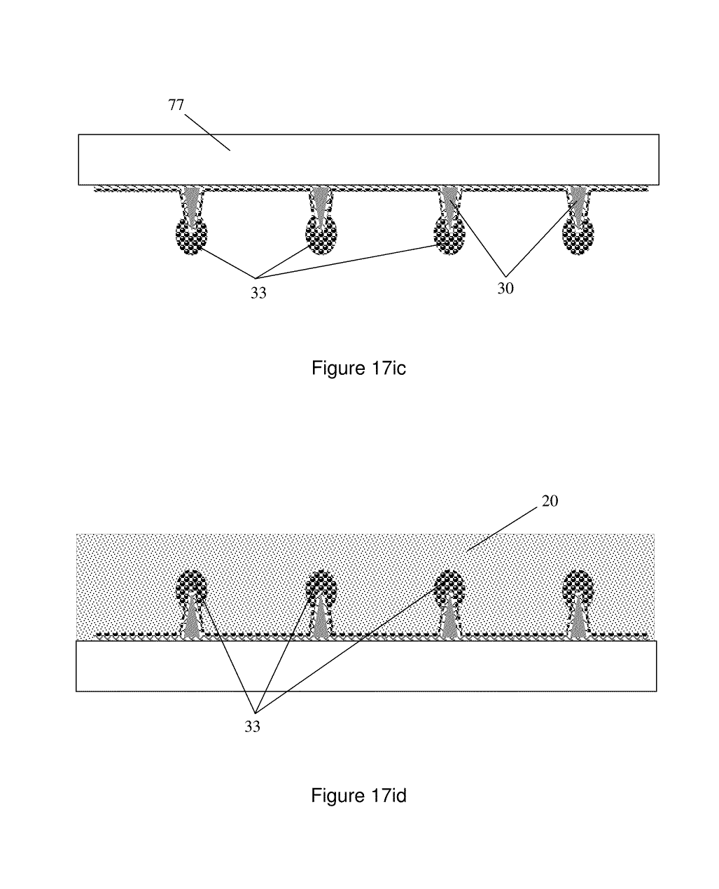

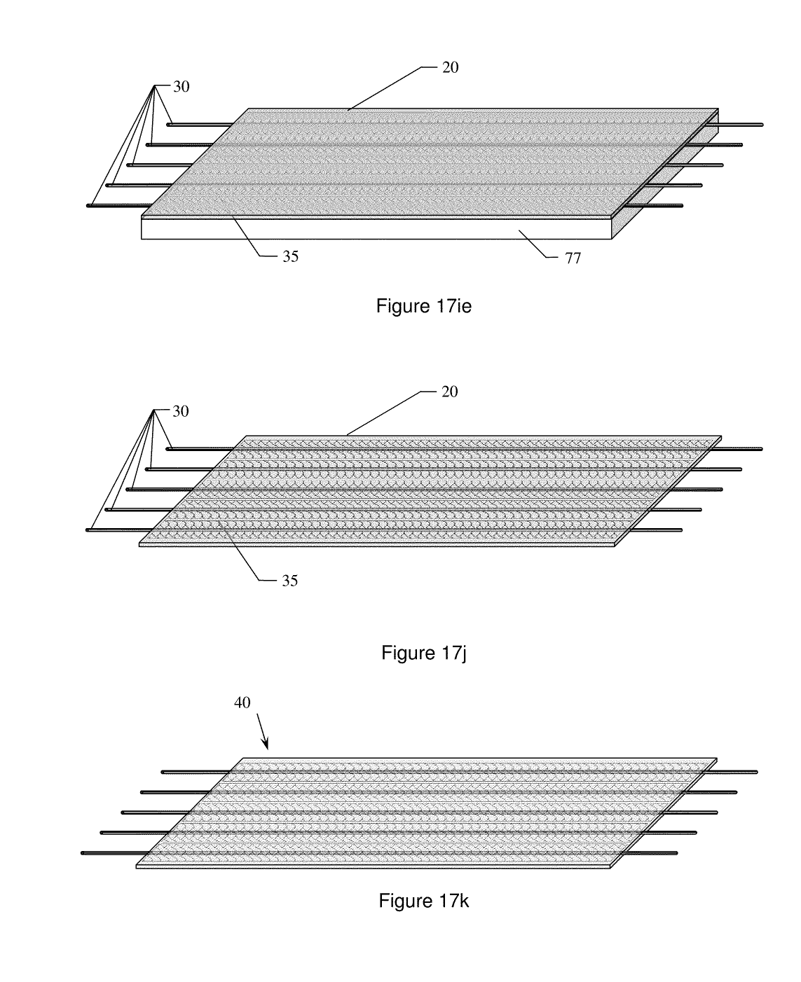

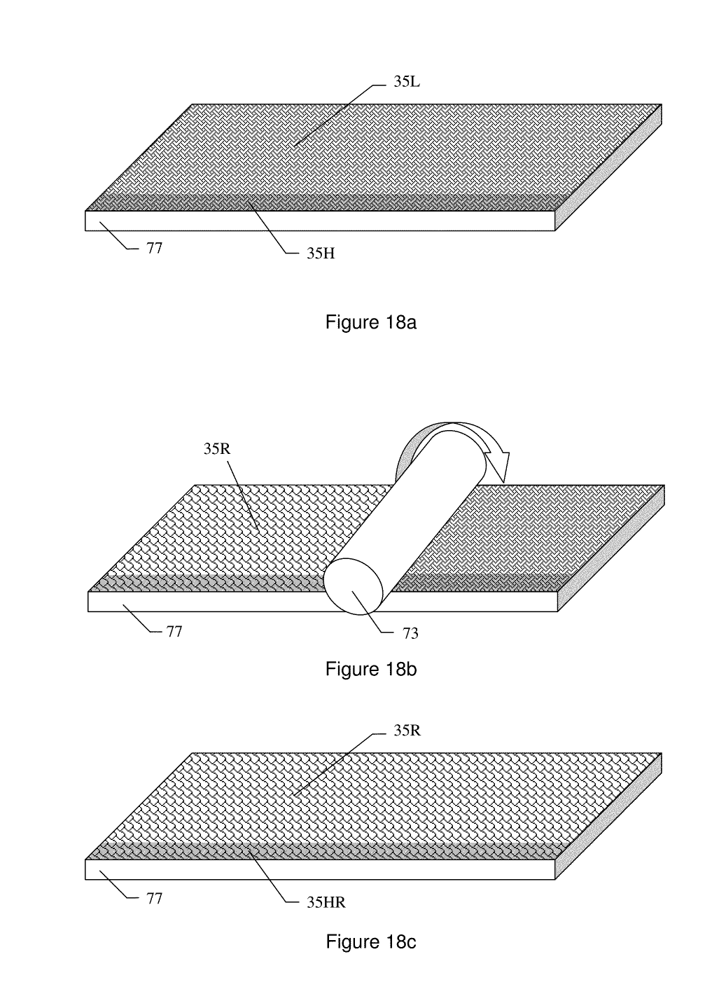

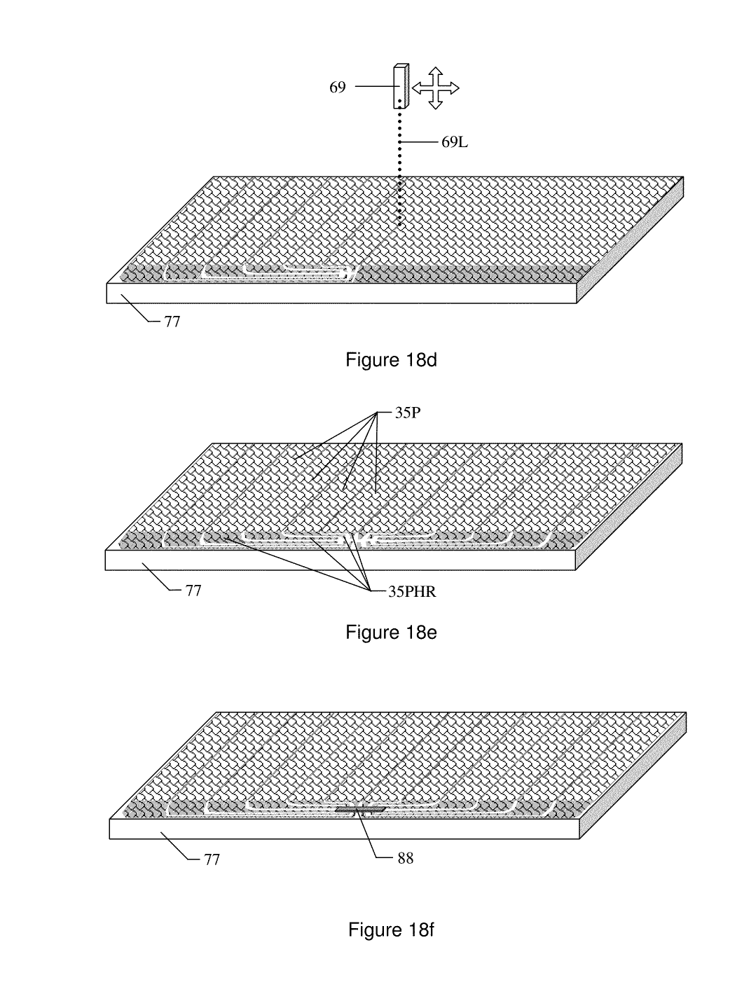

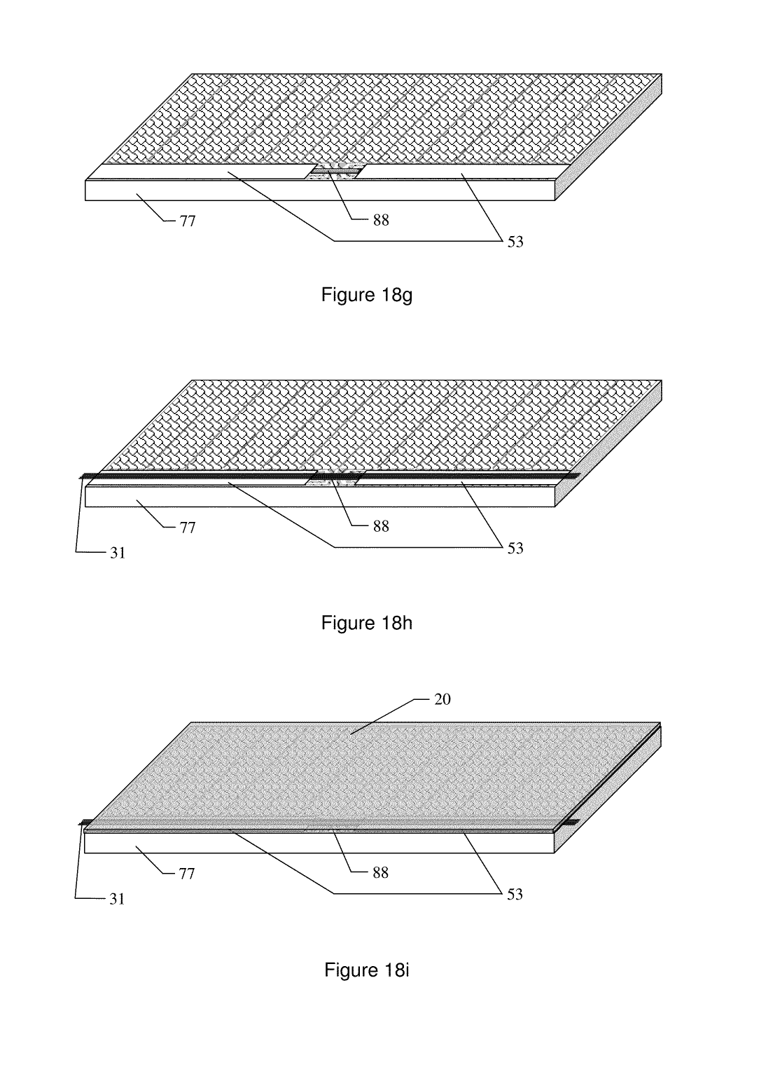

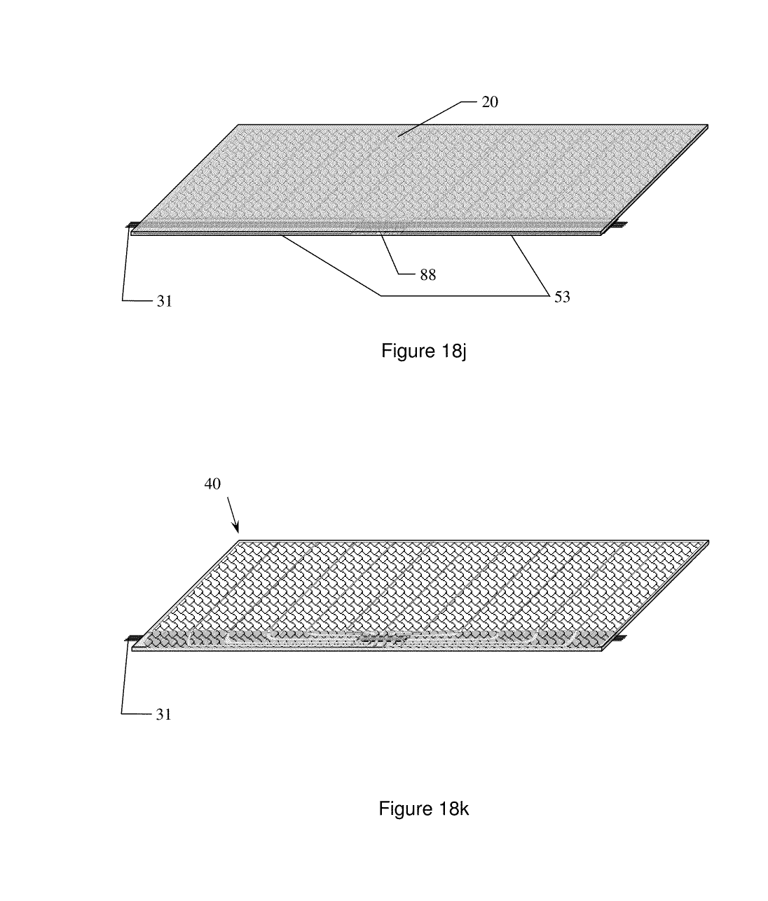

A variant on the eSheet process from that disclosed in the above referenced patents is shown in FIGS. 17 and 18. FIGS. 17 and 18 show an eSheet process where the electrode structure (30 & 35) is built up on a flat plate 77 and then the eSheet 40 is removed from the flat plate 77. The process starts with a flat plate 77, as shown in FIG. 17a. The flat plate has to be at least as large as the desired eSheet 40 and the surface has to be less than 0.5 μm flat and preferably less than 0.1 μm flat. A good candidate for this flat plate 77 is fusion drawn glass, like manufactured by Corning Inc. Fusion drawn glass is used to make LCDs and meets the tight flatness tolerances required for liquid crystal displays. An even better candidate for the flat plate 77 is ion exchanged fusion drawn glass, such as Gorilla Glass made by Corning Inc. Ion exchanging the glass surface will make a tough scratch resistant surface to form and replicate the eSheets. The flat eSheet replicating plate 77 can be made out of any substance that can withstand the processing conditions of the eSheet 40 such as an inorganic, like sapphire, or a metal or glass plate. In order to remove the eSheet 40 from the flat plate 77 after forming it, the flat plate 77 may need to be coated with a release layer 78, as shown in FIG. 17b. The release layer 78 can be a sacrificial layer that gets removed during or after the eSheet 40 is removed from the flat plate 77. The release layer 78 could also be a flat plate coating that reduces the adhesion strength of the eSheet 40—flat plate 77 interface. Note that this surface layer will be the interface that ultimately touches the liquid crystal material 35. Therefore, several different layers could be combined into this step to form the desired liquid crystal interface layer. Although the cholesteric liquid crystal material does not require a rubbing layer, a rubbing layer could be combined into this step for a different type of liquid crystal material.

The next step in the process is to add the transparent conductive layer 35L to the flattening plate 77. FIG. 17c shows a silver nanowire layer 35L added to the flattening plate 77. Silver nanowires is a new type of transparent conductive electrode being developed by Cambrios Technologies Corporation and C3Nano Incorporated. The transparent conductive layer could be made out of many different types of transparent conductive materials such as conductive nanotubes, nanowires, nanorods, graphene, conductive polymers, or conductive inorganic films like ITO or ZnO:F. The transparent conductive electrode material 35 used in the eSheets 40 to form the cholesteric liquid crystal panels 10 shown in FIGS. 11, 12, 15 and 16 was a dual material made of single wall carbon nanotubes and a transparent conductive polymer. The transparent conductive polymer material has a slight blue tint. This slight bluish tint works well in the multi-layered cholesteric LCD because the Blue cholesteric liquid crystal material is on top, therefore any blue light that doesn't get reflected will slightly get absorbed before it reaches the back black absorbing layer. This slight blue absorption will enhance the display contrast and the look of the display. A metal nanowires will plastically deform when rolled down tight against the flat plate, as shown in FIG. 17d. The transparent conductive electrode 35R could also be roll coated onto the flat plate in a single transfer step. Using a roller 73 with surface structure will allow for a pattern layer to be printed directly onto the flat plate.

In a wire-based eSheet, a wire array 30 is placed down onto the transparent conductive electrode material 35R, as shown in FIG. 17e. The wires 30 have to be electrically bonded to the transparent conductive electrode material 35. Pressure can be applied to the wires 30 to bond them to the silver nanowire coated flat plate. The pressure, which can be applied by a roller, will help lower the electrical resistance of the contact between the wires and the transparent conductive electrode material. Heat can also be added to the structure to lower the junction resistance and bond the wires. The wires can be strung across the flat plate or can be rolled down on the flat plate using a grooved roller. The wires 30 can have virtually any cross-sectional shape; examples of some of the shapes are shown in FIG. 17f i-vi. Creating a long, thin wire cross-section, as shown in FIG. 17f vi, and standing the wire 30 up vertically onto the flat plate 77 will allow the maximum amount of light to be transmitted through the eSheet 40. The wires 30 can be made out of any base material as long as they are electrically conductive and form a low junction resistance with the transparent conductive electrode material 35. Copper is a low-cost, highly conductive wire material, but it has a orange reflection when placed into an eSheet. The wires 30C can also be coated with a conductive material, as shown in FIG. 17f vii-viii. This coating can be used to change the reflection or remove the reflection from the wire electrodes. The coating can also be used to lower the junction resistance between the wire 30C and the transparent conductive electrode 35R. The coating can also be used to increase the adhesion between the wire and the transparent conductive electrode. Lensing effects can also be designed into the wire shape and coating to maximize the amount of light transmitted through the eSheet.

The next step in the process is shown in FIG. 17g, where the transparent conductive electrode is patterned 36 into electrode stripes. A laser beam 69L from a laser 69 can be used to ablate the silver nanowire film 35R between subsequent wires 30, thus creating electrically isolated lines. The laser scored region 36 should be as narrow as possible because the liquid crystal 35 will not switch where there is no electrode beneath it to support the electric field through the liquid crystal. Laser scoring machines are industrial grade equipment that can be designed and built to traverse very long distances economically scoring multiple lines at once, thus creating very long electrically isolated eSheet electrodes. FIG. 17h shows a fully patterned electrode structure 35P on the flat plate 77. Note that each individual wire 30 is electrically isolated from its adjacent wires 30. Each wire 30 is electrically connected to the silver nanowire film along the entire length of the transparent conductive electrode 35. Therefore, each wire 30 with attached transparent conductive electrode stripe 35 will form one row (or column) of pixels in the display. Any voltage applied to a wire will flow down the wire and be spread across its connected transparent conductive electrode stripe. Since the voltage only has to be spread from the wire 30 to the electrically isolated region 36, which is only half a pixel width, the transparent conductive electrode 35 does not have to be very electrically conductive. The higher the electrical conductivity of a “transparent conductive electrode film 35L” the less light gets transmitted through the film (or the more the film absorbs light). Therefore, the short charge spreading distance will only require a lightly conductive silver nanowire electrode 35L, hence creating a very transparent electroded sheet, eSheet 40.

The next step in the process is to apply the substrate material 20 overtop of the electrode structure, as shown in FIG. 17ie. Since the wires and transparent conductive electrode material are made of metal and the flat plate can be made of glass, metal or an inorganic material, this substrate application step can be done at high temperatures. One method of applying the substrate material is to vacuum mold a plastic film down onto the electrode structure. The vacuum during the vacuum molding process has to be less than 200 mTorr and preferably less than 100 mTorr to remove any voids from the electrode-polymer-flattening plate interface. Any voids can be problematic because they will stop the electrode structure (30 &35) from adhering to the polymer substrate 20 and the electrodes (30 &35) will not remove cleanly from the flat plate 77. If the plastic substrate 20 is vacuum molded to the electrode layer (30 &35) then the polymer 20 will have to be a stiff hard plastic that is well below its glass transition temperature when the vacuum is released. The polymer substrate 20 has to be in a very low elasticity region when the vacuum pressure is released or the wires 30 will protrude out of the surface creating a non-flat eSheet 40 surface and subsequent shorts in the LCD panel 10. The substrate application step can also be done in multiple layers, as shown in FIGS. 17ia and 17ib. A first layer 38 can be deposited to hold all the silver nanowires 35 together while the second layer 20 can create the supporting substrate structure. The first layer 38 can also be used as a barrier layer to prevent any contaminants moving from a subsequent substrate material 20 into the electrode structure, hence the liquid crystal. The eSheet substrate material 20 can also be an inorganic, such as a silicone. A silicone-based material will create a much higher temperature capable eSheet. One method of creating a silicone-based substrate material is to mix nanosilica particles in a thin, low viscosity silicone binder. This nanosilica/silicone mixture can then be applied to the electrode structure to form a somewhat rigid electrode back 38. A thicker silicone material 20 can then be deposited on top of this mixture to form a thicker supporting substrate.

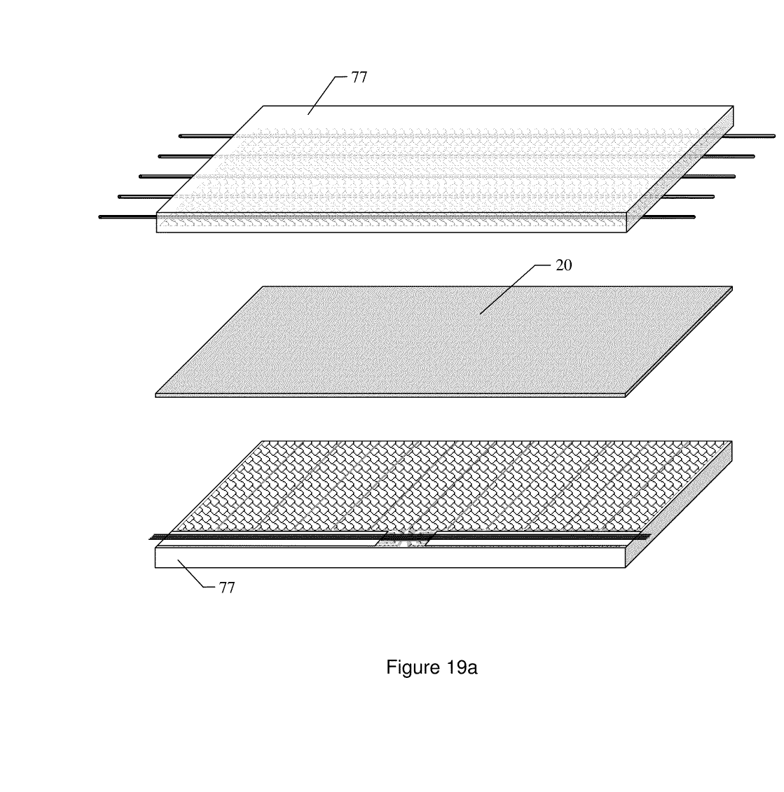

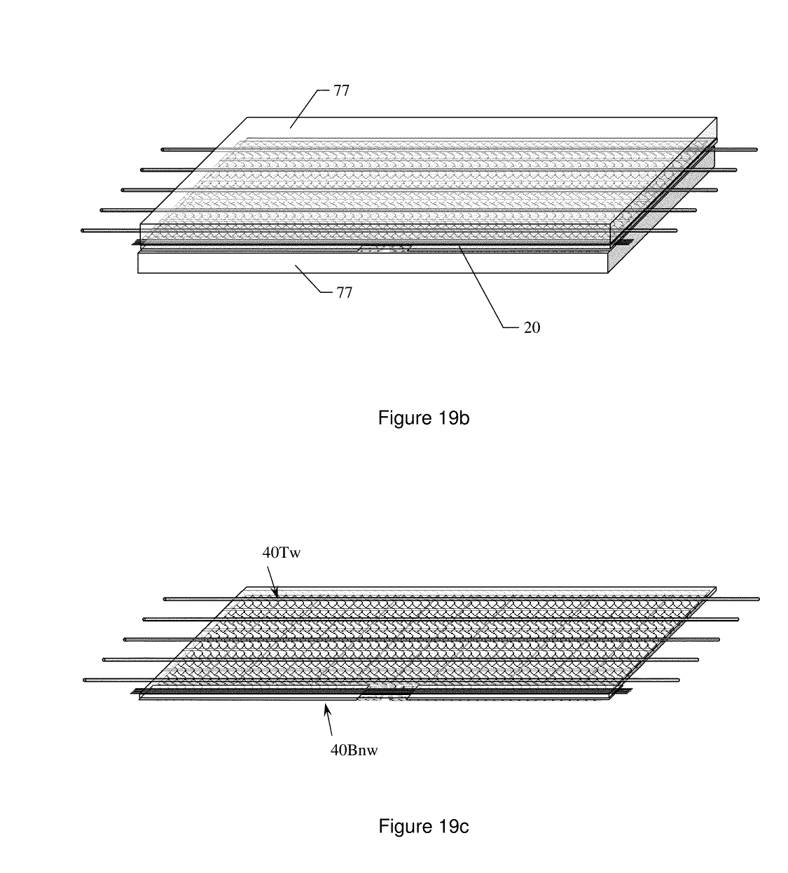

FIG. 17ic shows a method of adding an optical material 33 to the ends of the wire electrodes 30 to help bend the light around the wire electrodes 30. These wire cloaking globes 33 can help hide the electrodes 30 and remove their reflections. FIG. 17id shows that if the wire cloaking globes 33 are a higher temperature material than the eSheet substrate material 20 then the electrode structure can be embedded into the substrate material 20 without effecting the wire cloaking globes 33. If the eSheet being formed is to be used as the back eSheet 40B in the display, then the substrate material can be made out of a black or colored absorbing material, as depicted in FIG. 8. If the eSheet substrate being formed is an intermediary layer in a colored display then a second eSheet substrate 40Tw can be bonded to the back of the first eSheet substrate 40Bnw to form a double-sided electroded substrate, as depicted in FIG. 19c.

Once the entire eSheet structure 40 is completed, it can be removed from the flat plate 77, as shown in FIGS. 17ie and 17j. The bottom of the eSheet, or the side that was in contact with the flat plate, will be a replica of the flat plate 77 surface. Therefore, to form an eSheet 40 for a LCD display, it is imperative that the flat plate 77 be extremely flat with no surface imperfections. The final eSheet substrate 40 with the electrode structure up is shown in FIG. 17k. The high aspect ratio eSheets are narrow, thus several eSheets 40 can be formed on a single flat plate 77.

The LCD in an eShelf has a very high aspect ratio. A high aspect ratio display is one where the width of the display is at least 3 times larger than its height. To cover the shelf edge in a grocery store aisle the LCD may have to be 2 inches tall by 52 feet long. Therefore, creating an aspect ratio of 312:1 or an LCD where the length is 312 times longer than its height. Wires can easily be used to address the 52 foot long direction, however wires will not be required in the short 2 inch direction. A similar eSheet forming process, shown in FIG. 18, can be used to fabricate this electroded display substrate. This alternate eSheet process can have the drive electronics chips 88 embedded directly into the eSheet 40. The eSheet formation process starts, similar to FIG. 17, with a flat plate 77 and any release layer or bottom film 78. The flat plate 77 can then be coated with a silver nanowires layer 35L and one edge of the flat plate 77 can be coated with a heavy silver nanowire coating 35H, as shown in FIG. 18a. Note that silver nanowires are used in this example as the transparent conductive electrodes and the more highly conductive bus electrodes. The transparent conductive electrode layer 37L and the heavy conductive layer 35H could also be composed of other conductive materials. The heavy silver nanowire coating 35H is outside of the display area, therefore it does not have to be transparent. The silver nanowires 35 can then be rolled flat down against the flat plate 77, as in FIG. 18b. FIG. 18c shows the final rolled silver nanowire coatings 35R and 35HR. Note that either or both of the silver nanowire coatings could be roll coated directly onto the flat plate. They can also be roll coated with the electrode pattern on the roll coating machine.

There are many different patterning techniques to convert the transparent conductive coating into a patterned electrode film. My favorite method is to use a laser 69 to score 69L the electrode pattern into the silver nanowire film 35R, as shown in FIG. 18d. Both the address lines 35P and drive lines 35PHR for chip bonding can be patterned into the silver nanowire film 35P and 35PHR, as shown in the finished scored structure in FIG. 18e. There are many ways of creating the transparent conductive electrodes 35P and the drive electrode lines 35PHR.

One of the key features of the eSheet process is its release from the surface of a super flat plate 77 to form the electrode addressing structure flat enough for the liquid crystal display panel. If the release is super clean then the resulting eSheet substrate surface will be very flat and smooth. One of the biggest tricks to remember when forming the electroded sheet is to vacuum form onto the flat plate 77 interface to remove any voids (bubbles) in the eSheet surface. I always try to shot for below 100 mTorr. Get above 200 mTorr and there starts to be enough molecules in the interface or voids to create dips, bubbles or open structure in the eSheet surface after forming One of the most important reason for a vacuum is to get whatever “fluid” that is applied over/through the electrode structure to flow and fill any open structure. Therefore, the electrodes will be coated and bonded together. A well bonded electrode structure that is well bonded to the base substrate material 20 will cleanly release from a flat plate 77.

Another key feature of the eSheet process discussed above is that the polymer substrate does not get added until after the electrode structure is formed on the flat plate 77. This key process feature unlocks the electrode capabilities on polymer substrates. The electrode structure can be formed at extremely high temperatures then the polymer sheet 20 can be added and then peeled of off the flat plate 77. Therefore, getting all of the added benefits of high-temperature processing of the electrode structure with the low-cost flexibility of a polymer substrate. Many different methods can be used to apply the electrode structure to the flat plate 77. Intaglio or a standard printing press is one of the lowest cost, but one of the most flexible is inkjet printing. Conductive inks can be “sprayed” in very small droplets to form fine lines, features and gaps. Thick pastes of long nanowires can also be printed in the highly conductive bus electrode areas. While depositing the long nanowires or carbon nanotubes and aligning them in the bus line direction they will be similar to stranded wire. In fact, the conductive effects of the wires 30 in FIG. 17 could be formed by depositing conductive nanowire, nanorod, nanotubes, or other highly conductive materials, on the flat plate 77. These highly conductive materials could be printed on the flat plate 77 in many different electrode patterns. Creating a electroded web structure where the highly conductive electrode material is deposited on each side of the isolation layer, therefore creating a highly transparent web across the pixels. Placing the conductive electrode structure next to the isolation line softens the look of the score line. Forming the electrode structure onto the flat plate 77 also provides a rigid flat substrate to create the electrode structure on before transferring it to the surface of a flimsy polymer sheet to form an eSheet 40.

The next step in the process is to bond the driver chips 88, to address the short lines in the display, to the patterned film 35P on the edge of the panel, as shown in FIG. 18f. Note that the schematic only shows 12 patterned electrode lines 35P and one driver chip 88. If a 52 foot long eShelf is being fabricated with a 30 dpi LCD then it will have 18, 720 electrode lines. If the driver chips can drive 64 display lines then 293 chips will have to be placed along the 52 foot long edge of pattern electrode. A high temperature process step could be used to bond these chips to the electrodes, as well as, pressure down on the driver chip.

Drive lines to address the chips can also be included in the heavy silver nanowire coating 35H onto the flat plate edge outside of the driver chips (not shown in the schematic). Another method to power and address the driver chips 88 is to connect all the driver chips 88 up by electrically attaching a wire array 31 to the back side of the driver chips 88, as shown in FIGS. 18g and 18h. The drive lines 31 to power and address the chips 88 can be an array of wires connected to electrode pads on the backside of the driver chips 88. The ribbon cable 31 can house the ground, chip power, 5 V, clock signal, data signal, and any Boolean chip operators. Isolation film patches 53 will have to be placed over the electrode area between driver chips 88, as shown in FIG. 18g. A wire array 31 can then be strung up across the driver chips 88 along the entire length of the eSheet 40. The wires 31 are then electrically bonded (soldered) to the “topside” of the driver chips 88. The wire array 31 can also be adhesion bonded to the isolation film patches 53 forming a ribbon cable along the edge of the eSheet 40.

If the addressing electrodes on the glass sheet can be probed then power can be consecutively applied across adjacent electrodes to check for electrical shorts. A short in the isolation region will create more heat than the rest of the electrode film. This heat can be detected using a thermal camera and the short can be burned open with a laser. If the driver chips and wire electrodes can be connected to and powered then they can be used to create the power in the electrode grid to check for shorts.

The next step in the process is to apply the substrate material 20 over top of the electrodes 35, driver chips 88, isolation film 53, and the data wire ribbon cable 31, as shown in FIG. 18i. The substrate material 20 can be applied using techniques similar to those described above in FIG. 17i and in referenced U.S. Pat. Nos. 8,089,434, 8,106,853, and 8,166,649, which are included herein by reference. Once the eSheet substrate material is well bonded to all of the electrodes, electronics, wires, and films, it can be removed from the flat plate 77, as shown in FIG. 18j. Note that the driver chips 88 are included inside the eSheet substrate 40 and their outputs are ready to drive the short display electrodes 35 and their inputs are connected to an embedded wire array 31 that extends out the end of the eSheet 40. Note that at the beginning of the process a nonconductive film may need to be applied to the flat plate underneath the heavy silver nanowire coating 35H to hold the electrodes 35P to the driver chip 88, or the patterned electrode 35P to the isolation film 53 during the release process step. The final eSheet 40 substrate with the electrode structure 35 up is shown in FIG. 18k.

A monochrome eShelf's display 10 can be fabricated by sandwiching a liquid crystal material 45 between the two orthogonal eSheet 40, as shown in FIGS. 11 and 12. However, to form a color display, individual blue 10B, green 10G, and red 10R panels have to be stacked one on top of the other. The junction between the two color panels will require an eSheet panel 40 similar to that in FIG. 17 fused to an eSheet panel similar to that in FIG. 18. These two eSheet panels 40 can be combined as one during manufacturing. FIG. 19a shows how the dual-sided eSheet substrate can be formed by sandwiching the eSheet substrate material 20 between eSheet electrodes from FIG. 17h and eSheet electrodes from FIG. 18h. After the eSheet substrate material 20 is melted and bonded to the eSheet electrodes (30 & 35), as shown in FIG. 19b, the flattening plates can be removed to form a double-sided eSheet (40Tw & 40Bnw), as shown in FIG. 19c.

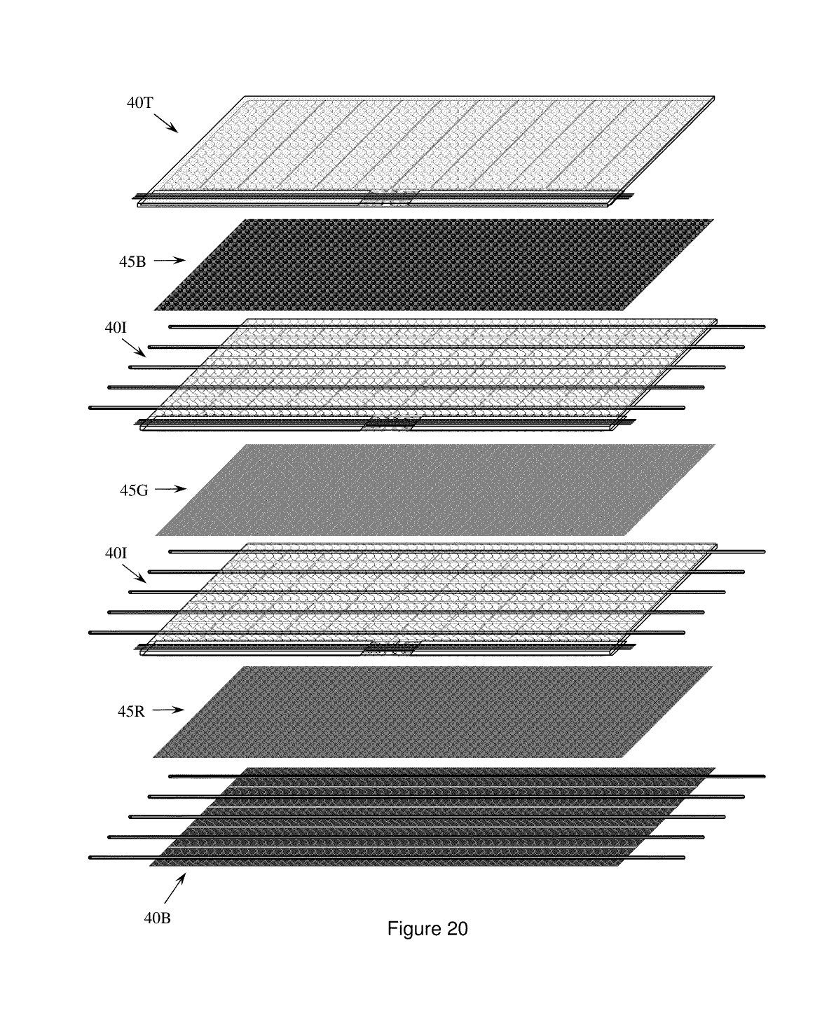

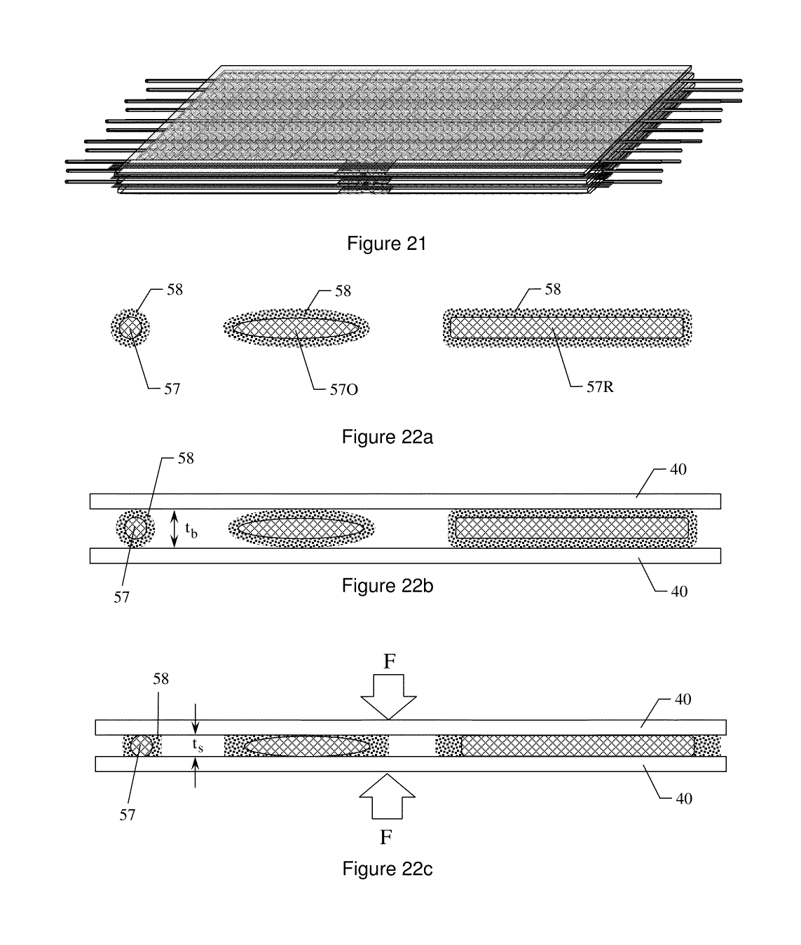

FIG. 20 shows the combination of eSheet substrates discussed in FIGS. 17, 18, and 19 that are used to create a full-color eSheet LCD. The top eSheet panel 40T will be composed of an eSheet with only transparent conductive electrodes. Therefore, there will not be any wire electrodes in the top eSheet panel display area. The top cholesteric LC layer 45B is blue because blue light has a more difficult time traveling through mediums than red (it gets absorbed quicker), therefore, red is the deepest in the color stack. An intermediate dual-sided eSheet 40I is used to modulate one side of the blue cholesteric LC with the wire-based electrode side and the green cholesteric LC 45G with the short transparent conductive electrode side. Another dual-sided eSheet 40I is used to address the other half of the green 45G and half of the red 45R cholesteric LC materials. A back black light absorbing wire-based eSheet 40B is used to apply one-half of the modulation signals to the red cholesteric LC 45R and is black to absorb any light coming through the display panel. FIG. 21 shows all the eSheets stacked up sandwiching there colored cholesteric liquid crystal materials.

Liquid crystal spacers have to be included in the liquid crystal layer to achieve the proper cell gap. The optimum cell gap of cholesteric liquid crystal panels are between 4 μm and 7 μm for a single cholesteric liquid crystal twist. The optimal cell gap thickness depends on the actual color of the cholesteric liquid crystal material. The liquid crystal spacers 57 can be coated with a polymer 58 that bonds the two eSheets 40 together during the panel forming process, while keeping the controlled cell gap. FIG. 22a shows three different shaped liquid crystal spacers; round 57, oval 570, and rod 57R (which could be formed by chopping a fiber). The hard spacers 57, 570, an 57R have softer adhesive coatings 58. FIG. 22B show the LC spacers placed between eSheets 40. Note that the LC cell gap, t_{b}, is equal to the spacer 57 diameter plus twice the thickness of the adhesive layer 58. FIG. 22C shows that when force, F, is applied to the eSheets 40 and the temperature is raised high enough to soften the polymer coating on the spacer 58 then the polymer 58 flows and the eSheets 40 are squeezed down to a LC cell gap, tₛ, of the spacer 57 diameter. If the spacer's 57 adhesive coating 58 bonds well to the eSheet substrates 40 then a rigid structure will be formed across the LC cell gap.

Bonding the liquid crystal interface between the eSheets together will have several advantages. The first advantage is that bonding all of the eSheets together will form a single structural solid unit that will keep the colored pixels aligned in the three layers. Fusing the panels together while the electrodes throughout the panel are aligned will provide the truest color reproduction of the image. Creating a solid multi-panel brick during manufacturing will keep all three panels aligned over the life of the product. Holding the eSheet panels together with coated spacers will also help when rolling or bending the final display. Not being able to sheer the liquid crystal layer during bending will help prevent shorts from forming in the liquid crystal interface. Therefore, a very important step when producing the multilayer LCD panels is to use liquid crystal spacers, where the surface of the spacer can adhere to the eSheet surfaces. Locking the electroded plastic substrates together through the liquid crystal interface at every spacer to prevent any shearing at that liquid crystal interface will result in long-lasting, high-quality displays.

There are many different methods of aligning the multiple electrode layers before fusing them together. One method is to tension up each electroded sheet by pulling on the substrate material at many locations around the perimeter of each eSheet. If the eSheets are stacked one on top of the next and each individual eSheet tensioner can translate in multiple directions then the electrodes in each eSheet layer should be capable of being aligned. To get the electrodes in the multiple layers perfectly aligned heat may need to be added locally to the substrate to expand the polymer and align the electrodes. Current could be applied to the electrode lines. The eSheet tensioner ends could be conductive and provide the power to resistively heat the electrode area. Lasers can also be used to focus the energy into the locations that need expanding. The laser can selectively heat the wire electrodes, which will cause the area around the wire to expand to help align the multi-layered substrates. When the electrodes in the multiple layers are aligned plates sandwiching the panel squeeze the panel tight together. Pressure from the plates might be high enough if the polymer spacer coating is soft and tacky enough to bond the electroded surfaces together. One way to add heat to the spacer surface to soften its shell is to backfill the evacuated cell gap interface with hot gas while under pressure from the plates. Of course, the liquid crystal would have to be filled into the cell gap after the interface is spacer bonded together if a vacuum or gas/liquid flushing is required during the panel bricking or bonding process.

A protective glass interface can be incorporated during the spacer bonding or panel bricking step. Glass plates with optical adhesive can be added to the panel surfaces and with temperature and pressure can be bonded into the panel stack. Using ion exchanged glass plates, like Gorilla Glass made by Corning Incorporated, will keep the eShelf display panel light. The backside of the panel does not require the tough interface like the front of the eShelf display panel, therefore it can be made using thinner lighter weight materials like metal foil or thin rollable Willow Glass made by Corning Inc. Forming a solid glass-polymer-glass panel will produce a tough structure and will have the safety features of a car windshield. That is break but stay held together by the inside polymer display. Corning's ion exchanged Gorilla Glass with silver ions in the glass surface, which is less than or equal to 0.7 mm thick, and their Willow Glass less than or equal to 0.2 mm thick would be perfect candidates for the eSheet LCD glass envelope. Glass with silver ions in the glass surface will make the perfect antimicrobial surface for the eShelf's LCD interface in grocery stores.

Having the eSheets sealed together with bonded spacers will allow pressure to be applied to the liquid crystal during the filling process. The pressure in the liquid crystal interface could even be placed above atmospheric pressure after the LC filling process. Having the pressure of the liquid crystal layer above atmosphere will help stop voids from forming in the LC interface. Voids in the liquid crystal layer can form from air or water vapor penetrating through the eSheets into the liquid crystal layer. Most polymers can absorb about 5% air or water vapor as it slowly penetrates through plastics. Therefore, over time air and water vapor will get into the liquid crystal interface, if not kept out. The most effective method of keeping air and water vapor out of panel is to hermetically seal the eSheet panels between glass, metal or ceramic plates. Hermetically sealing the eShelf display between impervious substrates such as: glass, metal, or ceramic will keep air and water vapor from penetrating into the liquid crystal layer to create voids in the LC layer. A fully dehydrated eSheet polymer substrate sealed in the display acts as a sponge to absorb any air or water vapor leaking through the seal and into the panel over the life of the display.

Another method of preventing voids in the LC interface is to use an encapsulated liquid crystal between the eSheets. There are two different methods of forming this microencapsulated liquid crystal material. The first method is to form a microencapsulated liquid crystal emulsion and then apply this emulsion between eSheet substrates. The second method is to include additional chemicals into the liquid crystal that can phase separate from the liquid crystal afterwards to form an encapsulated LC material. Heat can be used to phase separate the liquid crystal into a microencapsulated material, however the most popular method is to use ultraviolet (UV) light. This UV phase separation is traditionally called a PDLC for polymer dispersed liquid crystal and is used for privacy windows. Kent Displays uses a similar UV phase separation and they call it, polymer induced phase separation (PIPS). The PDLC and PIPS processes create a microencapsulated liquid crystal layer in the panel that helps to keep the LC layer from forming voids.

Many different components can be added to the display panel such as: polarizers (both linear and circular), backlight or front light units, light guide plate, lens sheet, diffuser plate, homogenizers, reflector, color filters, alignment layers, and other films. However, reflective cholesteric liquid crystal displays do NOT require any of these components.

During the eSheet forming process structure can be molded into the surface of the substrate, as covered in U.S. Pat. Nos. 8,089,434, 8,106,853, and 8,166,649, which are included herein by reference. This surface structure could help anchor a liquid crystal molecule. Whereas, a different surface structure could provide bistability to a liquid crystal that otherwise would not be bistable. The surface structures that are used to interact with the liquid crystal need to be molded into the electroded surface side of the eSheet. Lenses (lenticular and Fresnel) can also be molded into the sheet surface opposite that of the electrodes. The lenses can be used to create 3-D or multiple-view displays.

The cost of cameras are becoming so low that they are ubiquitously showing up in products everywhere. Being able to acquire the shelf product(s) location data using low-cost camera images and pattern recognition software will provide a low-cost solution to align the eShelf pricing information with its corresponding products. In order to assist the camera/recognition software to distinguish products the eShelf pad should have demarking pattern on it. The demarcations captured in the images can be used to determine the size of the product and its location on the eShelf. If all the video from the eShelf images do not show any products on the shelf, then the computer needs to send a bare shelf or out of stock item to the stock boy or to the ordering software, respectively. Product management from video feeds will require immense computing power, which would be a perfect fit for cloud computing.

The product sensor pads can use the eSheet technology to build the sensor structure. Spools of wires can be paid-out to create extremely large wire-based sensor grid pads that can electrically sense anything resting on the pad at every crisscrossing wire location (tactel) in the pad. Similar to the benefits of using wires in the eSheet for displays, the eSheet sensor wires allow for very conductive electrode lines. The very conductive electrode lines will create sensors that have very high sensitivity. The highly conductive wires will be able to sense very small changes in the current or voltage along the line, thus creating a sensor grid with a very high dynamic range. This high dynamic range will be important when sensing products with a large difference in weight. The highly conductive wires will also allow for uniform drive currents and voltages along the sensor lines. The highly conductive lines will also allow for very uniform sensing along the lines of the sensors. Uniform sensing along the sensors is very important to accurately determine where the products are placed across the shelf. The eSheet process also provides very flat surfaces. These flat surfaces will be very beneficial when creating a uniform sensor pad where the response curve at each pixel or tactel in the pad is the same. Unlike the high-resolution eSheets required for LCDs, sensors only require low resolution eSheets on the order of ¼″ to 1″ pitch. The eShelf'sensor pads do not have to be transparent, therefore opening up the use of a much wider range of materials.

Many different types of sensors can be integrated into the shelf product sensor pad. A projected capacitive sensor can be integrated into the surface of the pad to measure the existence of products on the shelf. A projected capacitive sensor will be able to measure the size, shape and location of products resting on the shelf. Another type of sensor that can be integrated into the pad measures weight at many locations across the shelf. Weight sensor arrays can be fabricated in many different ways. Most weight sensors measure a change in resistance or capacitance when the sensor or tactel is deformed. There are other types of weight sensors, such as optical sensors that use gratings; however, these sensors are difficult and expensive to integrate into products. Temperature is a property that stores are most interested in tracking, especially in refrigerator and freezer areas. Temperature can be easily measured by integrating thermocouples into the sensor shelf pad. Some stores and distribution centers track RFID tags. Antennas to read these RFID tags can be integrated into the sensor pad. Antennas integrated into the eShelf can also be used to communicate to the store or customers. Near Field Communication (NFC) protocol or Bluetooth can be used to communicate through the antennas to nearby devices. The integrated eShelf antennas can also be used to wirelessly communicate to the store or customers using Wi-Fi or other wireless communication protocols.

A 90° rigid corner piece can be used to connect the reflective LCD to the sensor pad. This corner piece can contain the solar cells, batteries, cameras, wireless antennas, and other integrated electronics and devices. It could have the ability to be disconnected from the product sensor pad and connected directly to the metal shelf. The sensor pads could have special labels on the pad. The label could be indicative of what the sensor pad can achieve or be product safety warnings or advertising.

The eShelf main display is a reflective full-color LCD. The LCD is addressed one line at a time, therefore it will have trouble running at video rates. One nice feature of the cholesteric LCD is that in the fully ON mode it is transparent. Therefore, a transmissive or emissive display placed behind the cholesteric LCD will shine out through the cholesteric LCD. Therefore, the cholesteric LCD can be used as a no-power color display and the transmissive or emissive display can be used to create a video images that shine out through the cholesteric LCD. Many different types of displays can be used in combination with the cholesteric LCD, including passive backplane LCDs, active-matrix liquid crystal displays (AMLCDs), Plasma Display Panels (PDPs), Tubular Plasma Displays (TPDs), OLEDs, LEDs, fiber laser displays, or any other light-based display that can shine through the reflective LCD.

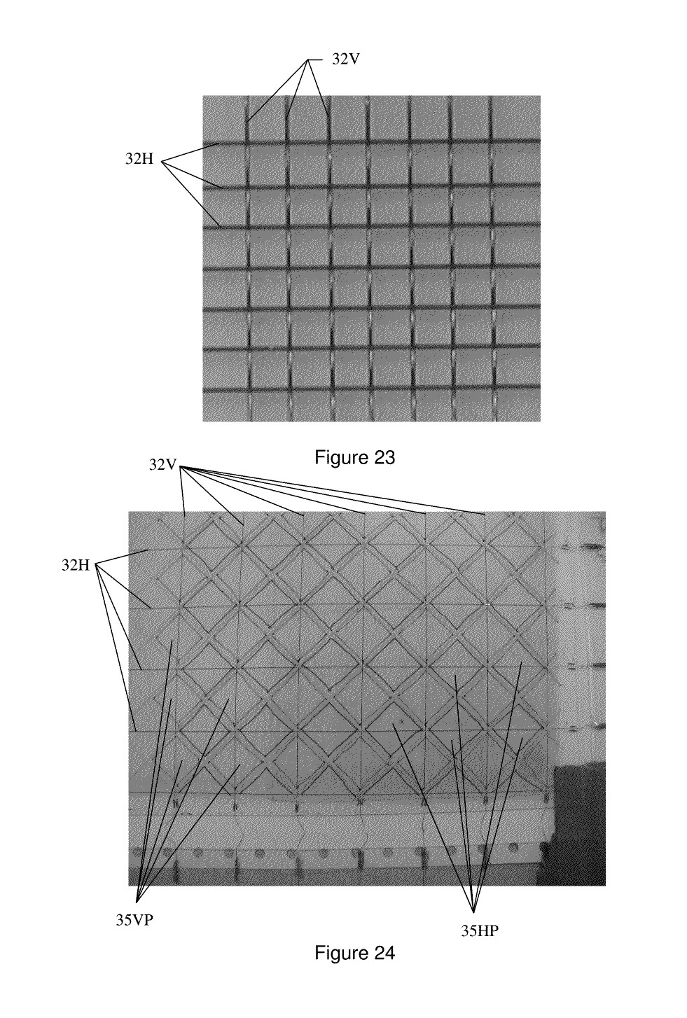

Wires 32 can be used to make a projected capacitive sensor array as disclosed in US patent application 20120105370 A1, included herein by reference. A projected capacitive sensor can be made by simply embedding crisscrossing arrays of coated metal wires (32H and 32V) into the surface of the plastic sheet, as shown in FIG. 23. Making the metal wires 32 (32H and 32V) out of a soft metal like copper will allow the bottom metal wires to plastically deform around the top metal wires when they are pushed into the surface of the polymer sheet. The best type of wire to use in this application is magnet wire. Magnet wire or enamel coated copper wire is copper wire covered with a thin multilayer insulation coating. This insulation coating keeps the wires electrically isolated from one another. The enamel coating on the copper wire can withstand temperature up to 250° C. allowing for rather high temperature wire embedding processes. The crisscrossing wires (32H and 32V) create an XY grid of conductors. By applying voltages to the XY array of conductors (32H and 32V) the local capacitance can be determined at each crisscrossing wire location or tactel. The electric field lines connecting the two wires at the crisscrossing location protrude out of the surface of the sensor. Placing an object over the sensor will distort these field lines in turn changing the local capacitance. Measuring the change in capacitance at each crisscrossing wire location or tactel will provide a map of what is resting on the surface of the sensor. The mutual capacitance between each orthogonal wire can be read one line at a time with no products resting on the eShelf. The capacitive map of the sensor surface can be stored in memory. As products are placed onto the sensor pad their capacitive signature can be determined by comparing the difference between the new capacitance map and the one in memory. As products are removed from the shelf their capacitive signature disappears letting the eShelf and store know the product has been removed from the shelf.

The sensitivity of the projected capacitive sensor can be increased by using more than one wire for the sense or address electrodes. The sensitivity of the projected capacitive sensor can also be increased by enlarging the effective footprint of the electrodes (35HP and 35VP), as shown in FIG. 24. The capacitive field strength that protrudes out of the surface of the sensor can be increased by patterning electrode pads (35HP and 35VP) onto the wire electrodes (32H and 32V, respectively). FIG. 24 shows that these additional electrode pads (35HP and 35VP) are transparent, which is imperative for a projected capacitive touch sensor overlay for phone, tablet or computer video monitor. However, these electrode pads (35HP and 35VP) do not have to be transparent for the eShelf'sensor pad and can be made out of any conductive material. This more sensitive projected capacitive sensor can be made by first removing the coating from the surface of the wires (32H and 32V) in the embedded crisscrossing wire grid. The wire isolation coating can be removed by simply sanding the surface of the embedded crisscrossing wire grid (32H and 32V). The isolation coating can also be removed by wet etching or laser ablation. The sensor surface can then be coated with a conductive electrode coating making good electrical contact to the wire electrodes. The conductive coating is then patterned at 45° and −45° crossing the wire junctions. This conductive film patterning creates diamond shaped capacitive pads (35HP and 35VP) along the wire electrodes (32H and 32V). FIG. 24 shows that the vertical wires 32V are connected to the green pads 35VP and the horizontal wires 32H are connected to the red pads 35HP. Note the red and green lines are drawn on the back of the eSheet capacitive sensor to depict the location of the capacitive pads. The transparent conductive film pad isolation line runs between the red 35HP and green 35VP electrode pads. The diamond shaped conductive pads in every row 35HP and column 35VP are connected to their corresponding wires (32H and 32V, respectively). Therefore any voltage applied to the wires (32H and 32V) will be spread out across the surface of the pads (35HP and 35VP, respectively). Likewise, any voltage sensed on the pads (35HP and 35VP) will be transferred down their corresponding wires (32H and 32V, respectively) to their electronics. Since the wires are free standing structures, they can be bent at any angle and even brought off of the sensor pad and connected directly to the drive and sense electronics.

The projected capacitive touch sensor can also be included into the surface of the LCD. The touch surface would allow the customer to interact with the display similar to how they presently interact with their smartphones. The touch interface on the LCD could allow the customer to view additional product information or to secure a digital coupon from the product.

The most simple and economical method of forming a weight sensor array is to use crisscrossing eSheets sandwiched around an inner deformable layer. Squeezing the eSheets together will deform the inner layer. If the inner layer is a resistive material then the increase in resistance corresponds to a load at the pixel or tactel. If the inner layer is electrically isolating then the deformation can be read as an increase in capacitance of the tactel. When the pressure is removed from the sensor, or the product is removed from the eShelf, the tactels springs back to their original shapes, returning the resistance or capacitance to their initial values, or a piezoelectric voltage down the line.

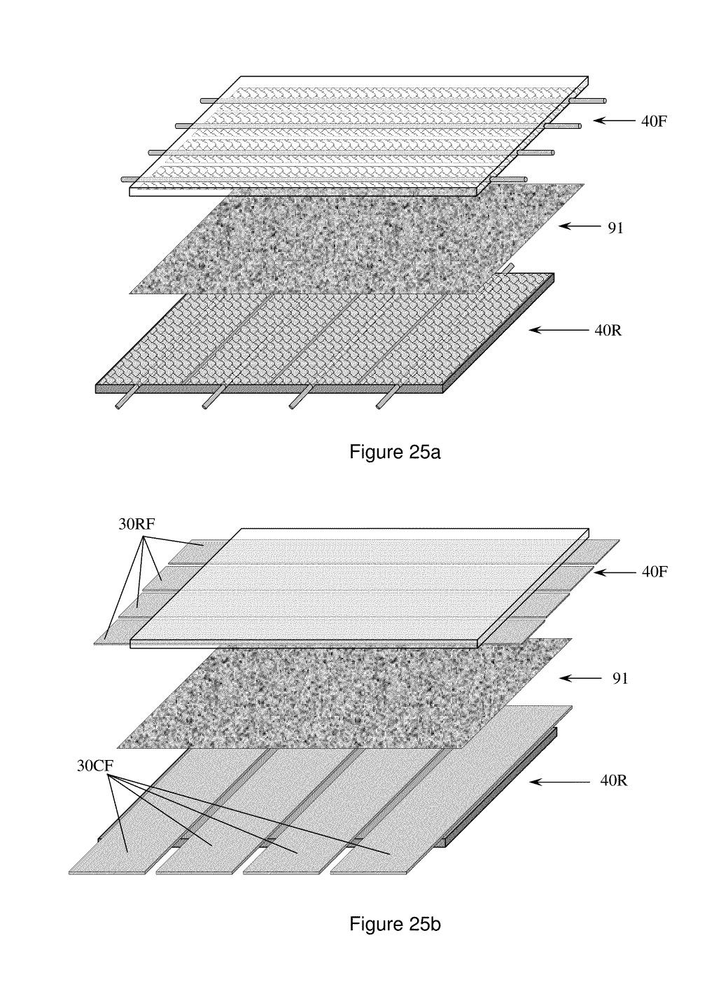

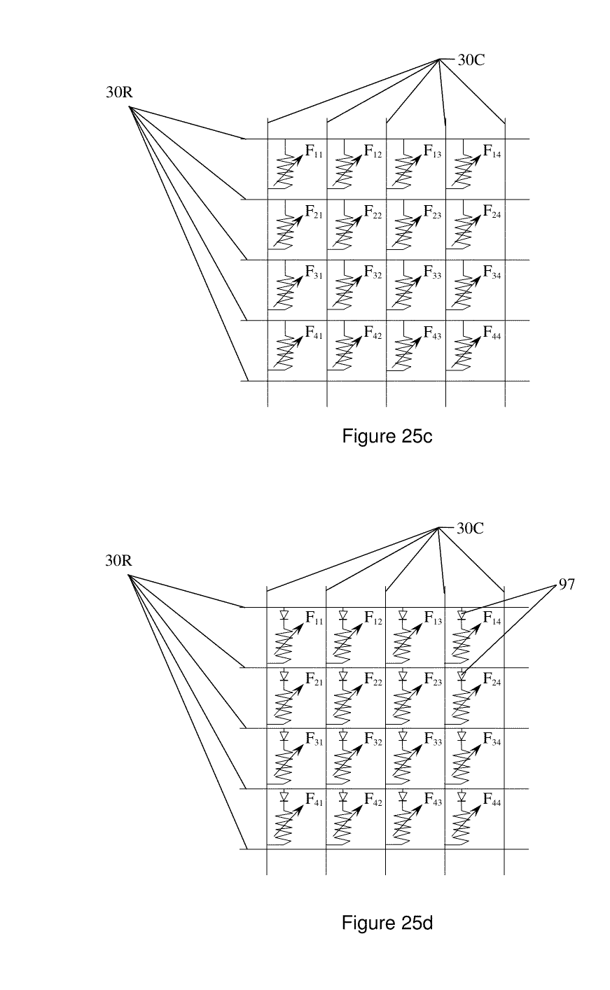

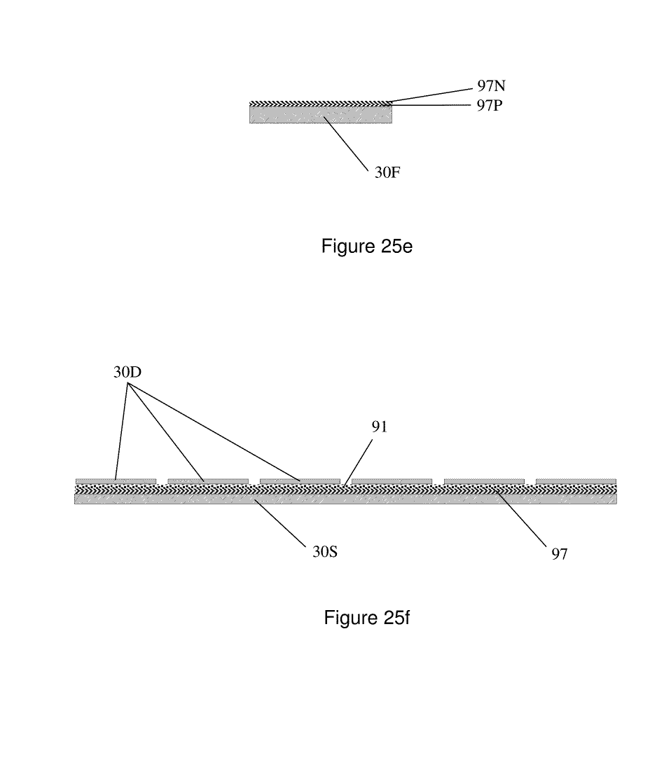

FIG. 25a represents a resistive sensor pad. Two electroded sheets (40F and 40R) sandwich a resistive material 91. The top eSheet 40F is flexible and deforms when pressure is applied to the surface. This deformation causes the inner piezoresistive membrane 91 to deform causing a change in resistance. Each row 40F or column 40R eSheet can be composed of more than one wire electrode. The wire electrodes (30RF and 30CF) can also be flattened covering the majority of area of that row of tactels, therefore not requiring an attached film electrode, as shown in FIG. 25b. Conductive wires virtually eliminate the parasitic resistance, such that the measured resistance is a resistive drop across the piezoresistive membrane 91. By knowing the calibration/loading resistance curve the actual force on the sensor can be calculated. The piezoresistive membrane 91 can be made out of any material that changes resistance when deformed. Most piezoresistive materials use conductive fillers in polymers or silicone. Examples of this composite piezoresistive material 91 are carbon-nanotubes filled in a silicone rubber or a composite of nanowires or conductive nanoparticles mixed in a soft polymer. Squeezing the composite piezoresistive membrane causes the conductive particles to better electrically connect up with one another, thus lowering the resistance across the junction. Electrical equivalent of the resistor sensor pad is shown in FIG. 25c. The piezoresistance matrix sensor is essentially a strain gauge at every pixel or tactel in the sensor. The sensor matrix can be read one line at a time by applying a voltage to the first row and measuring the current on each column electrode. This full line resistance/force read can be then done for each subsequent row in the sensor matrix, as shown in FIG. 25c. To limit the piezoresistive current from leaking out another data line, a pn diode 97 is placed in series with the piezoresistive material 91, as depicted in FIG. 25d. FIG. 25e shows that the diode (97N and 97P) can be deposited directly on the wire electrode 30F. Sandwiching the piezoresistive material 91 between the data 30D and diode 97 coated scan electrode 30S, as shown in FIG. 25f, will add a one-way switch or path for the current to flow through the scan/data circuit. Therefore, each row of tactels in the weight sensor can be scanned line-at-a-time without losing current to the other scanned rows.

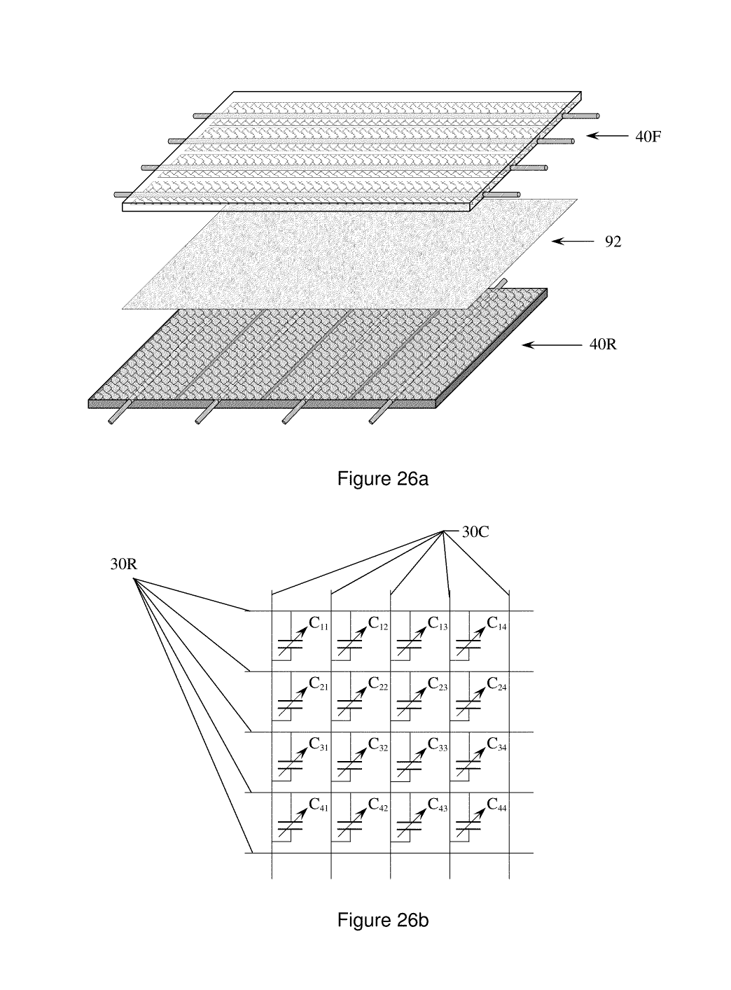

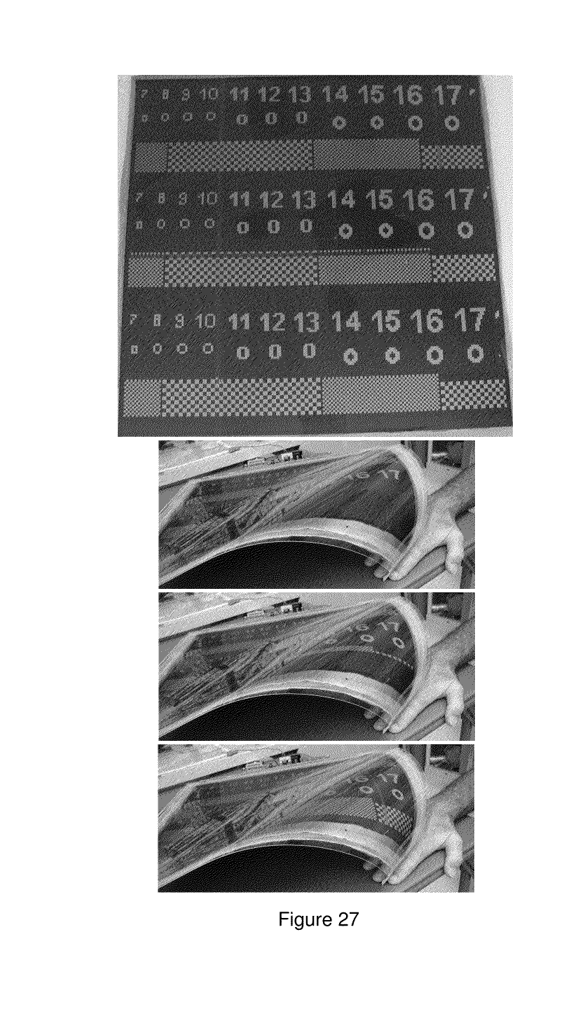

FIG. 26a represents a capacitive sensor pad. The capacitive sensor pad sandwiches a dielectric isolation material 92 between electroded sheets (40F and 40R). The dielectric isolation material 92 could be any deformable nonconductive membrane, including a solid, liquid, or gas. Any weight applied to the top of the capacitive sensor pad causes the top eSheet 40F and membrane 92 to deform. This deformation brings the top 40F and bottom 40R eSheets closer together, thus changing the capacitance between the eSheets. The cell or tactel capacitance can be read at each location that the electrodes in the top eSheet 40F cross the electrodes in the bottom eSheet 40R. The electrical representation of the tactel capacitance is shown in FIG. 26b. The stiffness of the top eSheet 40F and compressibility of the dielectric isolation membrane 92 will determine the capacitance/loading curve of the force sensor. The initial/no-load capacitance of each tactel in the sensor can be read one line at a time. The base capacitive map will serve as the no-load condition of the eShelf product sensor pad. Placing a product on the shelf will change the tactel capacitance underneath the product. The new capacitance map can be subtracted from the base capacitive map showing the change in capacitive map due to the product's weight. Knowing the calibration/loading capacitance curve, the actual weight of the product can be determined.

Building product sensors into the eShelf'sensor pad could drastically increase the cost of the entire eShelf'system. The lowest cost product sensor system would be to use images of the eShelf with location and direction of the camera's image data stamped into the image information. Therefore, obtaining the products shelf'stocking information and the location of the different products on the self relative to the location of the pixels or eShelf display image without spending any money on integrating sensors into the eShelf pad. Camera images with timestamp data of the camera's location in space and direction the camera was pointing when it acquired the image is the solution to determine the eShelf stocking information. Pattern recognition software using multiple eShelf images at different locations and different angles can be used to determine the exact conditions of the products resting on the eShelf. There are many different sensors that can be integrated with the image sensor in the camera to determine the location of the camera and direction it is pointing. Most of these sensors are presently integrated into smartphones and tablets. GPS can pinpoint the exact location of the camera in the store. An additional GPS signal can be generated inside the store by the store to help locate the exact location of the camera. Which direction the camera is pointing can be determined by the magnetic direction from the internal compass and the inclination from horizontal using an inclinometer. The camera's digital level could have a dual axis tilt sensor to not only determine the inclination of the camera but the twist of the image.

One logistical problem when shipping really long eShelves needed to cover the entire back wall of a Walmart or Lowe's is how to transport the product and install it in the store. The longest average tractor-trailer truck is 53 feet long. Therefore, the longest semi-rigid eShelf that could be shipped is about 52 feet. Since the eSheet LCDs can be rolled, as shown in FIG. 27, virtually any length eShelf is possible. However, even the conductive wire electrodes will start having difficulty keeping up with grayscale addressing much over 100 feet and will be incapable of latching into the super-bright planar state 35P over about 250 feet.

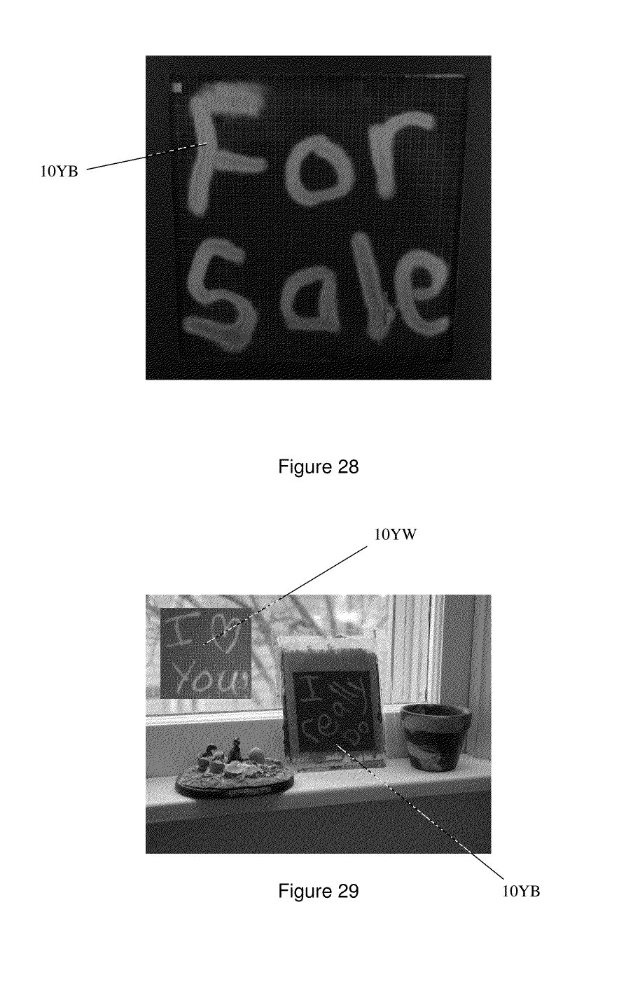

One aspect of the cholesteric liquid crystal display panel is that it can be made to be pressure sensitive. Images can be written onto the panel with a finger or a hard object (stylus) ‘kind of like an electronic magnadoodle or waterdoodle’, as shown in FIG. 28. “For Sale” was written into the surface by scratching my finger nail across the surface. Similar to the weight sensor discussed above, the inner liquid crystal can be deformed by applying pressure to the plastic eSheet LCD panel. This liquid crystal flow causes deformation in the crystal of the cholesteric liquid. When the bistable cholesteric liquid crystal flows it latches into the reflective Planar State 35P. Therefore, the cholesteric liquid crystal material will become reflective wherever the panel is mechanically written on. After an image is written onto the panel, it can simply be erased by applying an AC clearing voltage signal. A low voltage signal, above V₂ in FIG. 14, writes the panel into the Focal Conic State 35FC or forward scattering state. Sections of the panel can be electronically erased all the way down to the pixel level, if erase means lowering the reflective pixel level brightness (switching to the Focal Conical State 35FC).

The pressure sensitive cholesteric LCDs can be designed such that an image can be electronically written on the panel, or the panel can be written on using pressure from a finger or stylus (or a combination of both). Therefore, the displays can be both pressure sensitive and matrix-addressable. The ‘electrodoodle’ panels can be fabricated with a range of different cholesteric LC colors (red, yellow, green, or blue) with almost any color background. FIG. 29 shows a panel 10YW that has “I love you!” written in the yellow cholesteric liquid crystal interface. The “I ♡ you!” looks almost white because the back of the yellow cholesteric LCD panel was spray painted blue. The “I really do” eSheet cholesteric LCD panel 10YB, in FIG. 29, has a yellow cholesteric liquid crystal with a black background.

One concern about writing with a stylus on any plastic eSheet surface is scratches. To prevent scratching the plastic eSheet surface, it can be coated with a protective layer. A hard surface coating can be deposited on the plastic surface. Making the surface coating slippery, which will also help reduce surface damage. A thin glass microsheet could also be mechanically bonded to the eSheet surface. The glass microsheet will have to be thin enough to be easily deformed using a stylus or finger. The glass microsheet could also be ion exchanged to make it tough and not break when being mechanically written on.

Another aspect of the cholesteric liquid crystal display is that any image can be read after it has been written into the panel. Reading the image after it has been written only requires electronic connection or power when the image is being read, therefore serving as a very low power image acquisition solution. The pressure sensitive image written on the eSheet cholesteric LC panel can be read using the same orthogonal X-Y wire electrodes 30 used to electronically write an image on the panel. There is a large change in index of refraction between the reflective (Planar) state 35P [˜9] and the “transparent” forward scattering (Focal Conical) state 35FC [˜18]. The change in index of refraction is directly proportional to the square root of the dielectric constant (n∞√∈). The pixel capacitance (C) is directly proportional to the dielectric constant (C=∈A/d), where A is the area of the pixel and d is the thickness of the liquid crystal between the eSheets. Therefore, the lower the pixel capacitance the more reflective the pixel.

The phase of the cholesteric liquid crystal material at each pixel can be used to read the image written on the display panel. An image can be written on the display or it can be written to the “transparent” forward scattering (Focal Conical) state, black if the background color is black. The capacitance at each pixel can be measured one line at a time. An AC voltage can be applied to a scan line and sensed on the data lines to determine the capacitance at each pixel along that scan line. This process is then repeated for each scan line in the panel to determine the capacitance at each pixel. This initial pixel capacitance map can serve as the “background” reading at each pixel. The pressure sensitive panel can then be written onto or locally switched to the reflective (Planar) state using a finger or a stylus. To determine what has been written onto the panel the capacitance at every pixel can be remeasured and compared to the initially acquired capacitance map. The pixel capacitance difference between the reflective and transmissive states in the cholesteric LCD panels allows the image on the panel to be read at any time.

As an example of the change in capacitance due to a pressure sensitive phase change, we started with a 32×32 panel at 10 dpi that was written into the Focal Conical state. All of the wires on one side of the panel were tied together. The capacitance of a single 3.2″ long and 0.1″ wide line in the opposite direction was measured to be 4.87 nF. Pushing down directly over the line with a finger created a Planar phase change about ½″ diameter. The ½″×0.1″ Planar phase change along the 3.2″×0.1″ line decreased the capacitance to 4.43 nF. Rubbing the entire line and switching it to the Planar state caused the line capacitance to decrease to 2.70 nF. This simple experiment shows that the Focal Conical dielectric constant is about 1.8 times higher than the Planar dielectric constant and there is a large ˜5 nF/in² change in capacitance between the two states.

The ability of the cholesteric liquid crystal display to be both electronically addressed and mechanically written on, as well as, electronically read has great opportunity especially when the only time power is required is when a single display frame is being electronically written or read. The eSheet technology takes this amazing image writing and sensing ability and allows it to be achieved in a very large panel at very low cost. One small setback is that the displays nice tactile written ability is lessened when the pressure sensitive display is a multilayer colored stacked. Interacting with the eShelf should be more through a smart mobile device rather than a finger interacting with the surface of a color eShelf display.

One huge opportunity for large, reflective, ‘no-power’ matrix-addressable displays that also has pressure sensitive phase-change hand writing ability is School Blackboards. A low-cost, interactive, huge, electronic blackboard that requires very-little energy and can wirelessly connect to the Internet is a viable solution to remotely teach kids around the world.

Accordingly, it is to be understood that the embodiments of the invention herein described are merely illustrative of the application of the principles of the invention. References herein to details of the illustrated embodiments are not intended to limit the scope of the claims, which themselves recite those features regarded as essential to the invention.

What is claimed is:

1. A high aspect ratio liquid crystal display for an electronic shelf, wherein the panel of the display is composed of:
a) a polymer sheet containing transparent conductive electrodes extending in the short direction,
b) a second polymer sheet containing transparent conductive electrodes attached to conductive metal electrodes in the long direction, and
c) a liquid crystal material sandwiched between the two electroded polymer sheets.

2. The liquid crystal display in claim 1, further comprising adding additional polymer sheets containing electrodes sandwiching colored cholesteric liquid crystal materials between the electroded sheets to form at least a three color layered cholesteric liquid crystal stacked panel.

3. The liquid crystal display in claim 1, further comprising spacers in the liquid crystal layer that physically bonded to the two electroded polymer sheets together through the liquid crystal material.

4. The liquid crystal display in claim 2, wherein the electrodes in the multiple electroded sheet layers are aligned by locally heating at least part of one of the electroded polymer sheet with a laser to heat and expand the polymer substrate to align the electrodes.

5. The liquid crystal display in claim 1, wherein the liquid crystal material is microencapsulated.

6. The electronic shelf in claim 1, wherein more than two products are displayed on the high aspect ratio liquid crystal display.

7. The electronic shelf in claim 1, further comprising a product sensor pad attached to the high aspect ratio liquid crystal display.

8. The electronic shelf in claim 7, wherein the product sensor pad comprises at least one of the following:
a) patterns on the outside surface of the pad for optical rendering and product determination,
b) at least one thermal couple to sense temperature,
c) at least one antenna to sense a radio frequency tag,
d) at least one antenna to communicate to another wireless link,
e) at least one force sensor that measures the change in resistance to determine the weight of the product at the sensor location,
f) at least one force sensor that measures the change in capacitance to determine the weight of the product at the sensor location, and
g) a projected capacitive sensor.

9. The electronic shelf of claim 1, further comprising images from cameras of products on the electronic shelf where the cameras images are used to align the products data in the image on the high aspect ratio liquid crystal display with the products on the shelf.

10. The liquid crystal display in claim 1, wherein the process of forming an electroded polymer sheet is accomplished by:
a) applying the patterned electrode structure to a flat release plate,
b) molding the substrate material into the patterned electrode structure, then
c) remove the electroded sheet off of the flat release plate.

11. The electronic shelf in claim 1, further comprising an antenna so the electronic shelf can interact with at least one of the following:
a) a customer,
b) a store employee,
c) a merchandiser,
d) a contractor,
e) a smart mobile device,
f) a product on the shelf,
g) the store, or
h) Internet.

12. The electronic shelf in claim 1, further comprising adding at least one solar cell to the electronic shelf to power the electronic shelf.

13. The electronic shelf of claim 1, further comprising a central processing unit with an operating system running on the central processing unit.

14. The electronic shelf of claim 13, wherein the operating system runs software programs to allow people to interact with the electronic shelf.

15. The electronic shelf of claim 1, wherein at least part of the liquid crystal display is used for advertising.

16. An in-store product location system that determines the products and their location on the shelves and within the store that uses camera images of products on the shelf along with pattern recognition software and at least one of the following:
a) the location of the camera in the store when each image was acquired,
b) the direction that the camera was pointing when each image was acquired,
c) at least part of the price rail included in the images run through the pattern recognition software, or
d) any combination of a) through c).

17. The in-store product location system in 16, wherein the location of the products on the shelf is used to align the products information on an electronic display on the edge of the shelf rail.

18. The in-store product location system in 16, wherein the stocking and availability of products on the shelf is determined.

19. The in-store product location system in 16, wherein the images are obtained from at least one of the following:
a) a camera in the store ceiling,
b) a camera attached to the wall,
c) a camera attached to a shelf,
d) a camera attached to an electronic shelf,
e) a camera integrated into the surface of an electronic shelf, or
f) a camera in a smart mobile device.

20. A cholesteric liquid crystal display where an image can be written on the display by:
a) electronically addressing the pixels in the display by applying voltage waveforms to the electrodes in the display panel, or by
b) mechanically deforming the pressure sensitive liquid crystal material by using a stylus or finger to write directly onto the surface of the display panel,
wherein the final electrical and mechanically addressed image can be read using the same electrodes in the display panel used to electronically address the liquid crystal display at any time after the image is electronically or mechanically changed.
